(19) United States
(12) Patent Application Publication
(10) Pub. No.: US 2011/0097623 A1
(43) Pub. Date: Apr. 28, 2011

(54) SMALL-SCALE BATTERIES AND ELECTRODES FOR USE THEREOF

(75) Inventors: Thomas F. Marinis, JR., Haverhill, MA (US); Caroline K. Bjune, Andover, MA (US); Robert A. Larsen, Somerville, MA (US); Yet-Ming Chiang, Framingham, MA (US); Wei Lai, Cambridge, MA (US); Can K. Erdonmez, Miller Place, NY (US)

(73) Assignee: Massachusetts Institute of Technology, Cambridge, MA (US)

(21) Appl. No.: 12/866,966

(22) PCT Filed: Feb. 12, 2009
(86) PCT No.: PCT/US09/00901

§ 371 Date: Dec. 10, 2010

Related U.S. Application Data
(63) Continuation-in-part of application No. 61/027,842, filed on Feb. 12, 2008.
Application No. 61/027,842 is a continuation-in-part of application No. 61/118,122, filed on Nov. 26, 2008.

(51) Int. Cl. H01M 2/02; H01M 2/30

(52) U.S. Cl. 429/163; 429/178; 29/623.2

(57) ABSTRACT

The present invention generally relates to batteries or other electrochemical devices. In some embodiments, the present invention relates to small-scale batteries or microbatteries. For example, in one aspect of the invention, a battery may have a volume of no more than about 5 mm3, while having an energy density of at least about 400 Wh/l. Other aspect of the invention is directed to techniques of packaging such batteries.

### RELATED APPLICATIONS

This application claims the benefit of U.S. Provisional Patent Application Ser. No. 61/027,842, filed Feb. 12, 2008, entitled “Small Scale Batteries and Electrodes For Use Thereof,” by Marinis, et al., and of U.S. Provisional Patent Application Ser. No. 61/118,122, filed Nov. 26, 2008, entitled “Small Scale Batteries and Electrodes For Use Thereof,” by Marinis, et al. Each of these is incorporated herein by reference.

### FIELD OF INVENTION

The present invention generally relates to batteries or other electrochemical devices, and systems and materials for use in these, including novel electrode materials and designs. In some embodiments, the present invention relates to small-scale batteries or microbatteries.

### BACKGROUND

Since the time of Volta, batteries and other electrochemical devices have been fabricated by the manual assembly of critical components. The advent of distributed and autonomous electronics requiring very small and high energy density power sources, as well as continuing demand in larger batteries for low cost energy and power, has created a need for entirely new fabrication approaches for batteries and the like. Current devices range in length from micrometer-thick thin film batteries, to lithium rechargeable batteries based on wound laminate films, to the macroassemblies used in common alkaline and lead-acid batteries. However, as the size scale of powered devices continues to shrink, there is a growing need for distributed high energy density power sources of comparable size scale. However, the laminated construction techniques of current high energy density batteries (e.g., lithium ion batteries), now approaching their engineering limits, have inefficient mass and volume utilization, with only 30% to 40% of the available device volume being used for ion storage. Attempts to increase power density, for instance by using thinner electrodes, typically has come at the expense of energy density.

### SUMMARY OF THE INVENTION

The present invention generally relates to batteries or other electrochemical devices, and systems and materials for use in these, including novel electrode materials and designs. In some embodiments, the present invention relates to small-scale batteries or microbatteries. The subject matter of the present invention involves, in some cases, interrelated products, alternative solutions to a particular problem, and/or a plurality of different uses of one or more systems and/or articles.

In one aspect, the invention is directed to an article. In one set of embodiments, the article includes a battery comprising an entire anode, an electrolyte, and an entire cathode, where the battery has a volume of no more than about 5 mm³ and an energy density of at least about 400 W h/l. In another set of embodiments, the article includes a rechargeable battery having an energy density of at least about 1000 W h/1.

The article, in yet another set of embodiments, includes an electrode formed from a sintered ceramic, where the electrode has a porosity of no more than about 50%. In some cases, at least some of the pores of the electrode being filled with an electrolyte that is a liquid, a polymer. In still another set of embodiments, the article includes an electrode formed from a sintered ceramic that is able to retain at least about 50% of its initial storage capacity after at least 6 charge-discharge cycles at a C/20 rate.

In one set of embodiments, the article includes a micromachined electrode formed from a sintered ceramic comprising LiCoO₂. In another set of embodiments, the article includes a micromachined electrode formed from a porous sintered ceramic. In yet another set of embodiments, the article includes a micromachined electrode formed from a sintered ceramic, the ceramic having a linear strain differential of less than about 2%.

The article, according to another set of embodiments, includes an electrode having a base and a plurality of protrusions extending at least about 50 micrometers away from the base of the electrode, where at least some of the protrusions comprising LiCoO₂, and where substantially all of the protrusions having a surface and a bulk and being sized such that substantially all of the bulk is no more than about 25 micrometers away from the surface. The article may also include a nonporous electrolyte disposed on the surfaces of the protrusions.

According to yet another set of embodiments, the article includes an electrode comprising a base and a plurality of protrusions extending from the base, and a wall extending from the base and surrounding the plurality of protrusions. In some cases, the protrusions and the wall are formed from a unitary material. In another set of embodiments, the article includes an electrode comprising, on one surface, a plurality of protrusions and a wall surrounding the plurality of protrusions. In some cases, the electrode can be formed using laser micromachining.

In one set of embodiments, the article includes an electrode having a plurality of protrusions. In some cases, the protrusions have an aspect ratio of at least about 3:1 and a pitch of at least about 2:1. In one embodiment, the electrode is formed using laser micromachining. In another embodiment, the electrode is formed from a unitary material.

According to another set of embodiments, the article includes a lithium metal electrode, a nonporous electrolyte contacting the lithium metal electrode, and a porous sintered electrode contacting the lithium metal electrode.

In another set of embodiments, the invention is directed to an article and a physical design that is the hermetic package for a battery. The package may include a container, one or more lids or caps, electrical feedthroughs, seals and sealing materials for joining the lids or caps to the container, and/or insulating or conductive materials used to electrically connect or electrically insulate the internal components of the battery. In some embodiments the battery is a rechargeable lithium battery. In some cases, the battery is a microbattery with less than 10 mm³ total volume including the package.

Another aspect of the invention is drawn to a method. In one set of embodiments, the method includes an act of fabricating an electrode from a unitary material. In some cases, the electrode comprises, on one surface, a plurality of protrusions and a wall surrounding the plurality of protrusions.

In another set of embodiments, the method includes acts of providing a Li-containing substrate that Li metal will not wet, depositing a metal layer on the substrate, and adding Li metal to the metal layer. In some cases, the Li reacts with the metal layer to wet the surface.

According to another set of embodiments, methods are provided for assembling and packaging a battery including, methods of joining electrodes to the interior of a packaging container and/or its lid, passivating the interior of the battery with electrically insulating coatings to avoid internal short-circuits during assembly or use, and/or sealing the package. For instance, in one set of embodiments, the method includes acts of positioning a polymer film, or other substrate, containing one or more metallized portions containing solder adjacent a container containing a battery, heating the one or more metallized portions to at least partially melt the solder; and forming a seal between the container and the polymer film. In still another set of embodiments, the method includes acts of providing a container at least partially enveloping a battery having a volume of no more than about 10 mm³, and sealing the battery within the container using a polymer film containing one or more metallized portions.

In one set of embodiments, the method includes acts of positioning a metallic film containing solder adjacent a container at least partially enveloping a battery, heating the metallic film to at least partially melt the solder, and forming a seal between the container and the metallic film. In another set of embodiments, the method includes acts of positioning a ceramic film containing solder adjacent a container at least partially enveloping a battery, heating the ceramic film to at least partially melt the solder, and forming a seal between the container and the ceramic film.

In another aspect, the present invention is directed to a method of making one or more of the embodiments described herein, for example, a small-scale battery or a or microbattery. In another aspect, the present invention is directed to a method of using one or more of the embodiments described herein, for example, a small-scale battery or a microbattery.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1D illustrate electrodes having protrusions, according to one embodiment of the invention;

FIGS. 2A-2C are photomicrographs of an embodiment of the invention, illustrating an electrode having ribs;

FIG. 3 illustrates a sloped protrusion, in accordance with one embodiment of the invention;

FIGS. 4A-4C are photomicrographs of various embodiments of the invention having sloped protrusions;

FIGS. 5A-5B illustrate electrodes having walls, according to another embodiment of the invention;

FIGS. 6A-6E are photomicrographs of various embodiments of the invention, illustrating electrodes having walls;

FIGS. 7A-7D are photomicrographs of another embodiment of the invention, illustrating an electrode having walls;

FIGS. 8A-8B are photomicrographs of yet another embodiment of the invention, illustrating electrodes having substantially planar surfaces;

FIGS. 9A-9C are photomicrographs of still another embodiment of the invention, illustrating an electrode that does not show any obvious degradation or cracking;

FIG. 10 is a schematic diagram of one embodiment of the invention;

FIG. 11 is a schematic diagram of a method of fabricating a battery, in accordance with another embodiment of the invention;

FIGS. 12A-12D illustrate an embodiment of the invention using colloidal-scale self-organization to produce an electrode;

FIGS. 13A-13B illustrate the energy densities of batteries using various materials, in accordance with certain embodiments of the invention;

FIG. 14 illustrates energy density as a function of volume for various batteries, in yet another embodiment of the invention;

FIGS. 15A-15B illustrate the deposition of liquid lithium on a wet oxide surface, in accordance with still another embodiment of the invention;

FIGS. 16A-16B show electrochemical test results of porous LiCoO₂ electrodes prepared in accordance with certain embodiments of the invention;

FIGS. 17A-17B show various “cans” according to certain embodiments of the invention;

FIGS. 18A-18D illustrate the preparation of a battery within a can, according to one embodiment of the present invention;

FIG. 19 illustrates a battery of one embodiment of the present invention;

FIG. 20 illustrates a battery produced in accordance with another embodiment of the present invention;

FIG. 21 illustrates a battery produced in yet another embodiment of the invention;

FIG. 22 illustrates a battery of still another embodiment of the present invention;

FIGS. 23A-23B illustrate an example of a battery, in yet another embodiment of the invention.

FIGS. 24A-24B are photographs of components of an electrochemical cell package, according to one set of embodiments;

FIGS. 25A-25B are photographs of one set of embodiments of a component of an electrochemical cell package;

FIGS. 26A-26B are schematic illustrations of a component of an electrochemical cell package, according to one set of embodiments;

FIG. 27 is a cross-sectional schematic illustration of a component of an electrochemical cell package, according to one set of embodiments;

FIGS. 28A-28B are photographs of one set of embodiments of components of an electrochemical cell package;

FIG. 29 is a cross-sectional schematic diagram of an assembled electrochemical cell, according to one set of embodiments;

FIGS. 30A-30B are photographs outlining the process of sealing an electrochemical cell package, according to one set of embodiments;

FIGS. 31A-31E illustrate a set of embodiments in which current was measured as a function of voltage;

FIGS. 32A-32B are cross-sectional schematic diagrams of assembled electrochemical cells, according to one set of embodiments;

FIGS. 33A-33C are plots of voltage as a function of time, according to one set of embodiments;

FIG. 34 is a cross-sectional schematic diagram of assembled electrochemical cells, according to one set of embodiments; and

FIGS. 35A-35C illustrate a set of embodiments in which an alternative anode material is used.

### DETAILED DESCRIPTION

The present invention generally relates to batteries or other electrochemical devices, and systems and materials for use in these, including novel electrode materials and designs. In some embodiments, the present invention relates to small-scale batteries or microbatteries. For example, in one aspect of the invention, a battery may have a volume of no more than about 5 mm³, while having an energy density of at least about 400 W h/l. In some cases, the battery may include an electrode comprising a porous electroactive compound, for example, LiCoO₂, which may be formed, in some cases, by a process including but not limited to sintering of a particle compact. In some embodiments, the pores of the porous electrode may be at least partially filled with a liquid such as a liquid electrolyte comprising organic carbonates and/or a lithium salt such as LiPF₆, a polymer such as a polymer electrolyte comprising polyethylene oxide and/or a lithium salt, and/or a block copolymer lithium-conducting electrolyte. The electrode may be able to withstand repeated charging and discharging.

In some cases, the electrode may have a plurality of protrusions and/or a wall (which may surround the protrusions, if present); however, in other cases, there may be no protrusions or walls present. The electrode may be formed from a unitary material, e.g., formed using laser micromachining, dry etching processes such as plasma or reactive ion etching, wet chemical etching, or similar techniques. In certain embodiments, a nonporous electrolyte, such as lithium phosphorus oxynitride, a polymer electrolyte such as one based on polyethylene oxide and/or a lithium salt, a block-copolymer lithium conducting electrolyte, and/or a polyelectrolyte multilayer film (which may be formed by a layer-by-layer deposition process) may be disposed onto the electrode. Such an electrolyte may allow ionic transport (e.g., of lithium ions) while preventing dendritic formation due to the lack of pores. In certain embodiments the porous electrode has a surface that is denser than its interior. The denser surface may be formed by laser processing, rapid thermal annealing, formation of a surface layer with a higher powder particle packing density prior to sintering, filling of the surface with finer particles, application of a surface coating by a vapor phase deposition or a sol-gel coating process, or other such methods. Other aspects of the invention are directed to techniques of making such electrodes or batteries, techniques of forming electrical connections to and packaging such batteries, techniques of using such electrodes or batteries, or the like.

Various aspects of the invention are directed to batteries or other electrochemical devices. Generally, a battery includes an anode, a cathode, and an electrolyte separating the anode and the cathode. Current collectors may be electrically connected to the anode and the cathode, and current drawn from the battery using the current collectors. Typically, current is produced by the battery when the current collectors are put into electrical communication with each other, e.g., through a load, such as a light, a motor, an electrical circuit, a sensor, a transmitter, an electrical device, etc. Within the battery, ions flow through the electrolyte between the anode and the cathode during discharge. The electrolyte may be solid or liquid. In one aspect of the invention, the battery is a Li ion (Li⁺) battery, i.e., the battery uses Li⁺ as a charge carrier (alone, or in conjunction with other charge carriers) within the electrolyte.

In some cases, the battery is rechargeable, i.e., the battery can be charged and discharged more than once. For example, the battery may be able to withstand at least 3 cycles, at least 6 cycles, or at least 10 cycles of charging and discharging (for example at a C/20 rate, where 1 C=280 mA/g) with a retention of its initial storage capacity (e.g., as measured in W h) of at least about 50%, at least about 60%, at least about 70%, at least about 75%, at least about 80%, at least about 85%, at least about 90%, or at least about 95% relative to the initial charge of the battery after its first full charging. A rechargeable lithium battery typically has electrodes that exchange lithium during charge and discharge. For a cathode or positive electrode material, Li⁺ and electrons are adsorbed during the discharge of the battery, and this process is reversed during the charge. Though the present invention is not limited to cathodes, as used herein, “charging” indicates lithium removal from the positive electrode and “discharging” refers to lithium insertion into the positive electrode.

In some embodiments of the present invention, the battery is a “microbattery,” i.e., a battery having a volume of less than about 10 mm³, including the entire anode, cathode, electrolyte, current collectors, and exterior packaging that form the battery. In some cases, the volume of the battery may be less than about 5 mm³, less than about 3 mm³, or less than about 1 mm³. For example, the battery may be generally cube-shaped, having dimensions of less than about 3 mm, less than about 2.5 mm, less than about 2 mm, less than about 1.5 mm, or less than about 1 mm on each side. Of course, other shapes are also possible, for example, rectangular parallelepiped, disc, rod, plate, or spherical shapes, in other embodiments of the invention. In some embodiments of the invention, the battery may contain an electrode having a smallest dimension of at least about 0.2 mm, and in some cases, at least about 0.4 mm, at least about 0.6 mm, at least about 0.8 mm, at least about 1.0 mm, at least about 1.5 mm, or at least about 2.0 mm.

In one set of embodiments, the battery has an energy density of at least about 400 W h/l, i.e., the battery is able to produce 400 W h of energy for each liter of volume of the battery (including the entire anode, cathode, and electrolyte forming the battery). In some embodiments, even higher energy densities can be obtained, for instance, at least about 800 W h/l, at least about 1000 W h/l, at least about 1200 W h/l, at least about 1400 W h/l, or at least about 1600 W h/l. In other such embodiments, such energy densities can be obtained even when the current collector and packaging of the cell are included in the battery volume.

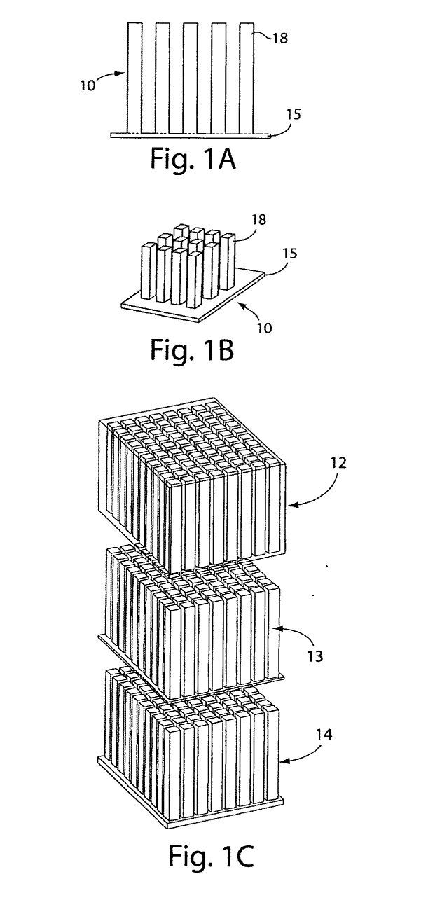

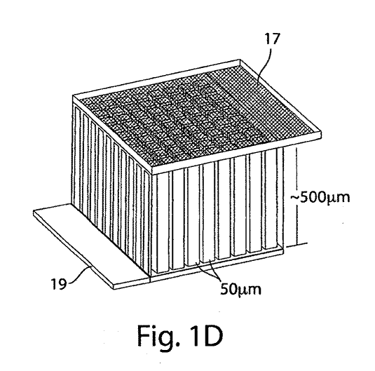

In one aspect of the present invention, such energy densities may be achieved by using a cathode having a shape such that substantially all of the cathode may be able to participate in lithium ion exchange, e.g., with the electrolyte during charge or discharge. For instance, in some embodiments, the electrode has a shape that allows a relatively high degree of exposure between the electrode and the electrolyte contacting the electrode, and/or a relatively thin cross-sectional dimension, which may facilitate transport of ions into and out of the electrode. In one set of embodiments, the electrode may have the form of a base and a plurality of protrusions, for instance, as is shown in FIG. 1A in side view. In this figure, an electrode 10 includes a base 15, and a plurality of protrusions 18 that extend away from the surface of the base. As used herein, the base of the electrode is defined as a generally flat, contiguous, featureless surface, and the protrusions are defined a series of extensions that each extend away from the base, although the base and the protrusions, in some embodiments are made from a unitary material, as discussed below.

As shown in FIG. 1, the protrusions are each shown as being generally rectangular; however, in other embodiments, the protrusions may be cylindrical, cone shaped, irregular, rectangular, pyramidal, etc., and may be distributed on the surface of the base in any manner, e.g., regularly or randomly arranged, etc. The protrusions on the base may each be substantially the same shape and/or size, as is shown in FIG. 1A, or the protrusions may have different sizes.

FIG. 1B shows an example of one electrode having a two-dimensional array of protrusions. In this figure, the cross-sections of the protrusions are generally square, although in other embodiments, other shapes are possible, e.g., rectangles or circles. FIGS. 1C and 1D shows a battery that includes such two-dimensional arrays of protrusions, used as a cathode and an anode, in exploded view (FIG. 1C), and when assembled (FIG. 1D), including top and bottom current collectors, in electrical communication with the anode and cathode, respectively. In FIG. 1C, battery 20 includes an anode 12, a cathode 14, and an electrolyte 13. In FIG. 1D, the battery is shown assembled, with a top current collector 17 in electrical communication with anode 12, and a bottom current collector 19 in electrical communication with cathode 14. Additionally, in FIG. 1D, as a non-limiting example, dimensions of a microbattery that could be formed using such electrodes are illustrated.

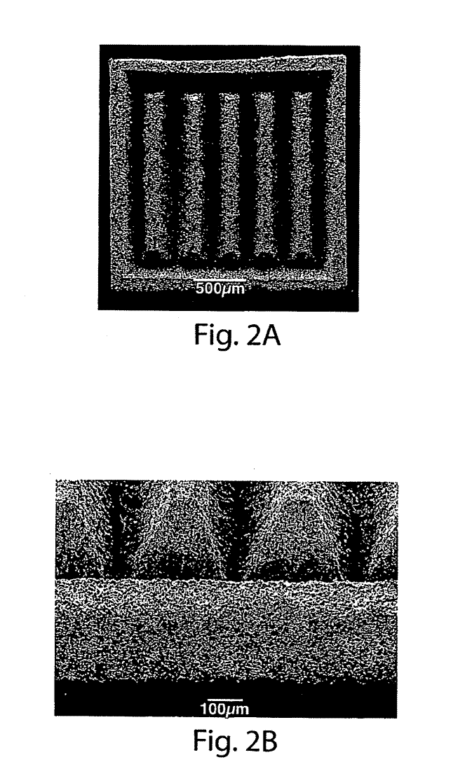

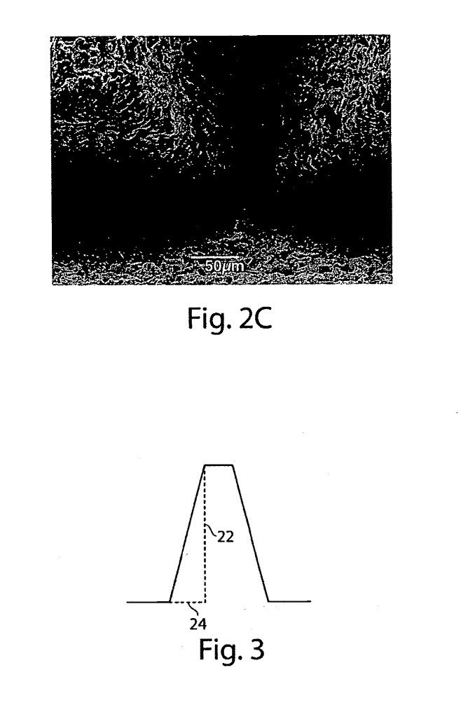

However, in some cases, the protrusions extend along one dimension of the electrode, thereby giving the appearance of “ribs,” that, when viewed in cross-section, has an appearance similar to that shown in FIG. 1A. An example of an electrode having such a series of extended protrusions is shown in FIG. 2A-2C at different magnifications. The electrode in this example was laser-machined from a porous sintered LiCoO₂ material, although other materials and other forming processes can also be used.

In some embodiments, the protrusions may extend a distance of at least about 25 micrometers away from the base of the electrode, i.e., the maximum separation of the end of the protrusion away from the surface of the base of the electrode is about 25 micrometers. In other cases, the protrusions may extend a distance of at least about 50 micrometers, at least about 75 micrometers, at least about 100 micrometers, etc., away from the base of the electrode. As mentioned above, not all of the protrusions may extend the same difference away from the surface of the base. In some cases, the protrusion may have an aspect ratio (i.e., the ratio of the distance the protrusion extends away from the base to the maximum thickness of the protrusion) of at least about 3:1, and in some cases, at least about 5:1, at least about 10:1, at least about 15:1, at least about 20:1, etc.

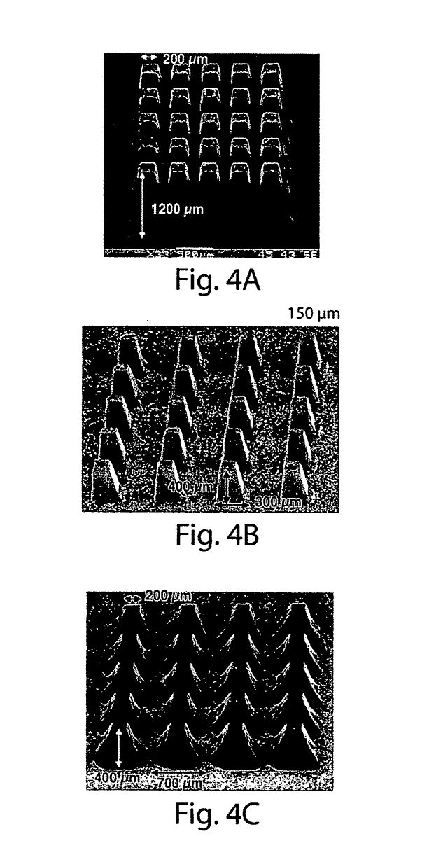

In some cases, the protrusions have sloped sides, i.e., sides that are not orthogonal to the surface of the base. For example, a protrusion may have a pitch of at least about 2:1, and in some embodiments, the pitch may be at least about 3:1, at least about 5:1, or at least about 10:1. The “pitch” of a protrusion, as used herein, is the slope of the protrusion, or the ratio of its “rise” to “run.” The sides of the protrusion need not all have the same pitch. As shown in FIG. 3, a protrusion may have sloped sides, and the pitch is the ratio of the rise of the slope 22 of the protrusion to its run 24. Photomicrographs of such sloped protrusions are shown in FIGS. 4A-4C. FIG. 4A shows sloped protrusions formed from polycrystalline graphite; FIG. 4B shows sloped protrusions formed from polygraphite on alumina, and FIG. 4C shows sloped protrusions formed from HOPG (highly ordered pyrolytic graphite) on alumina. Materials that can be used to form the electrode and/or the protrusions are discussed in detail below.

In some cases, the protrusions may have a shape and/or size such that the protrusion, or at least a substantial fraction of the protrusion, is not more than a certain distance away from the surface of the protrusion. Such a protrusion, for example, may offer a limited distance for Li ions to be transported within the electrode before reaching the surface or the electrolyte, and thus, in some cases, substantially all of the protrusion may participate in Li ion exchange during charging or discharging of the electrode, thereby increasing the efficiency and/or the power density of the electrode. For instance, a protrusion may have a surface and a bulk, where the protrusion has a shape and/or size such that substantially all of the bulk is no more than about 5 micrometers, about 10 micrometers, about 15 micrometers, about 20 micrometers, about 25 micrometers, about 50 micrometers, about 75 micrometers, or about 100 micrometers away from the surface of the protrusion.

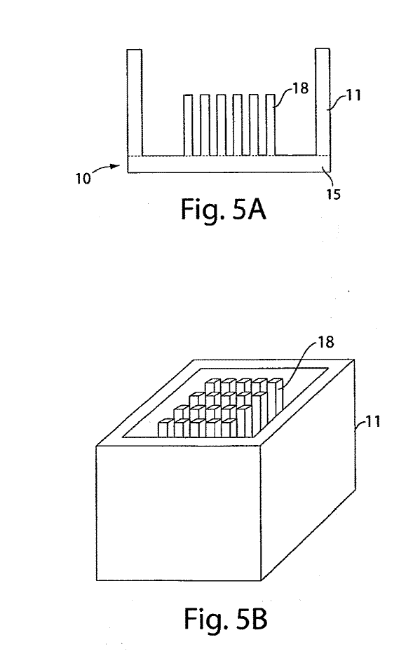

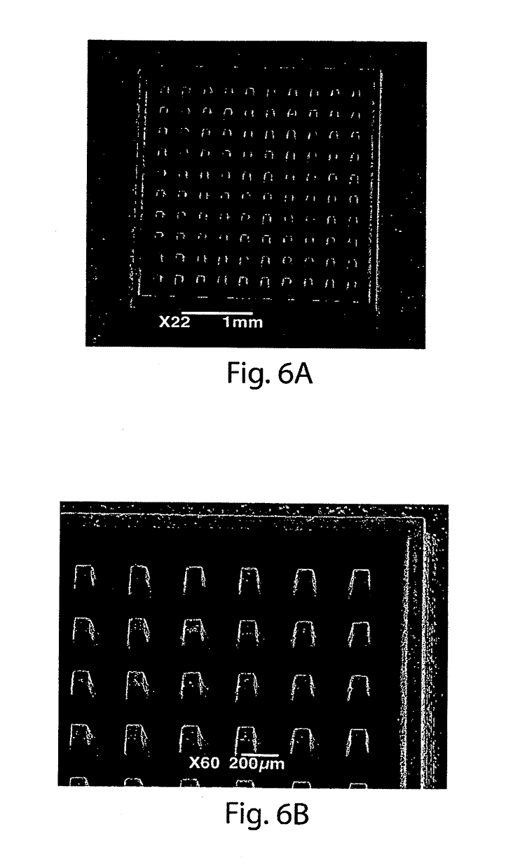

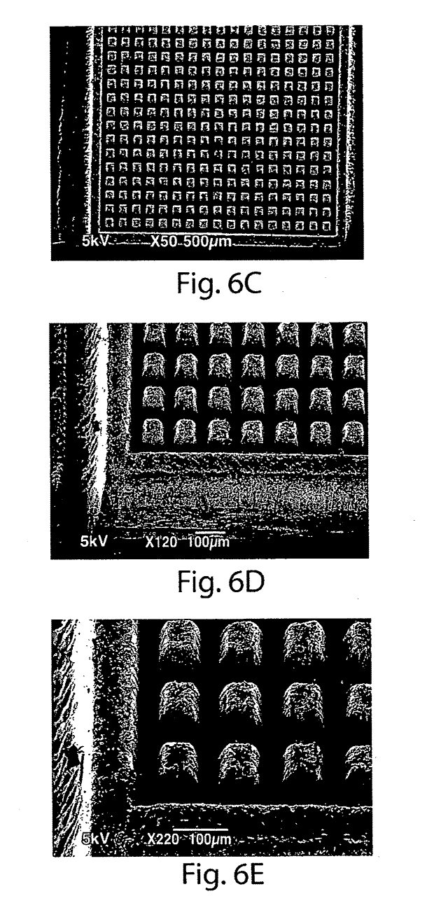

In certain embodiments, the protrusions on the base of the electrode may be at least partially surrounded by a wall or a “can.” For example, as is shown in FIG. 5A in cross section, electrode 10 includes a base 15, a plurality of protrusions 18 that extend away from the surface of the base, and a wall 11 surrounding the protrusions. A three-dimensional view can be seen in FIG. 5B, and photomicrographs of such electrodes are shown in FIGS. 6A-6E. In FIGS. 6A and 6B, the height of the walls and the protrusion is about 0.5 mm, and the width of the protrusions is about 100 micrometers. In FIGS. 6C-6E, the protrusions have a 100 micrometer pitch, and a feature width of 80 micrometers. The walls, as shown in this example, have a square or rectangular arrangement, but in other embodiments, other shapes are possible, for example, circular, hexagonal, triangular, etc.

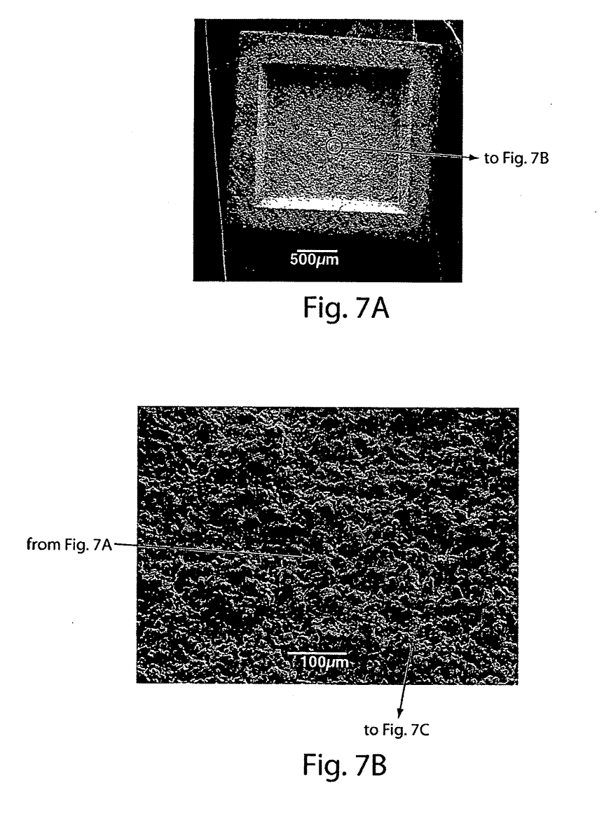

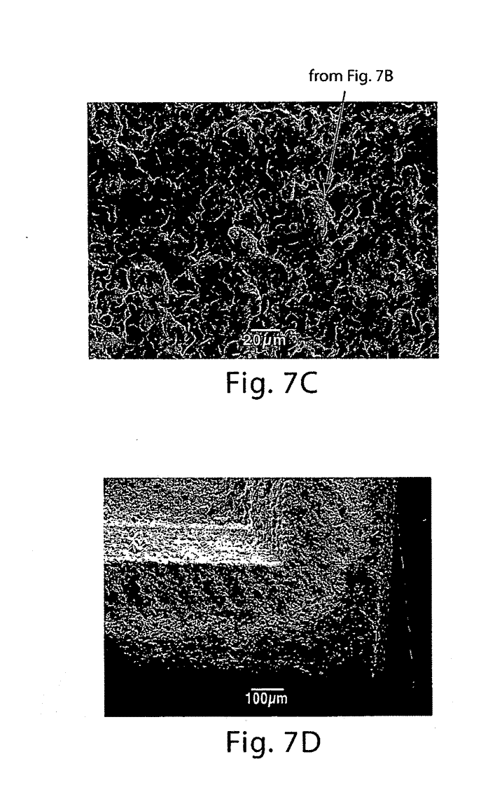

The wall may be same thickness as the protrusions, or of a different thickness. For instance, the wall may have a thickness of less than about 200 micrometers, less than about 175 micrometers, less than about 150 micrometers, less than about 125 micrometers, less than about 100 micrometers, less than about 75 micrometers, less than about 50 micrometers, or less than about 25 micrometers, and the wall thickness may be uniform or non-uniform. The wall may also be orthogonal to the base, or in some cases, the wall may have sloped or tapered sides. A non-limiting example of an electrode having a tapered wall is shown in FIGS. 7A-7D. In addition, as can be seen in FIGS. 7A-7D, an electrode may have a wall on the base without necessarily having any protrusions, in certain embodiments of the invention.

The wall may, in certain embodiments of the invention, be useful to contain an electrolyte and/or other materials within the electrode, i.e., such that it remains in contact with the protrusions of the electrode. The wall may also protect the protrusion from external factors, for example, from forces that might cause the protrusions to deform or break. In some cases, the wall may facilitate the construction of integrated electrode arrays, for example, for microbattery applications. In some cases, as discussed below, the wall is formed, along with the base and optionally the protrusions, from a unitary material. By forming the wall and the base from a unitary material, an airtight or hermetic seal between the wall and the base is naturally formed, which prevents leakage to or from the battery, e.g., leaking of the electrolyte contained within the electrode. In one set of embodiments, the walls and the protrusions are micromachined from a unitary ceramic material, as is discussed in detail below.

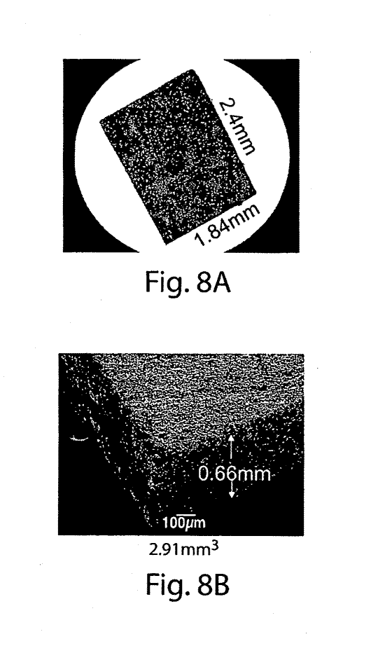

It should be noted here that not all embodiments of the present invention necessarily must include protrusions and/or walls. For example, in some embodiments, the electrode is a substantially planar surface, e.g., as is shown in FIGS. 8A and 8B for an example of an electrode formed in a monolithic shape from sintered LiCoO₂, and having a density of about 85%. Thus, according to another aspect of the invention, relatively high energy densities may be achieved, regardless of the shape of the electrode (i.e., whether or not the electrode is planar or has protrusions, walls, or the like), due to the porosity of the electrode. In some cases, as discussed below, due to the electrolyte-filled porosity of the electrode, substantially all of the electrode may be able to participate in Li ion exchange, e.g., with the electrolyte during charge or discharge.

In some cases, the electrode may have a smallest dimension that is at least about 0.2 mm, and in some cases, at least about 0.4 mm, at least about 0.6 mm, at least about 0.8 mm, at least about 1.0 mm, at least about 1.5 mm, or at least about 2.0 mm.

As used herein, “porous” means containing a plurality of openings; this definition includes both regular and irregular openings, as well as openings that generally extend all the way through a structure as well as those that do not (e.g., interconnected, or “open” pores, as opposed to at least partially non-connected, or “closed” pores). The porous electrode may have any suitable porosity. For example, the porous electrode may have a porosity of up to about 15%, up to about 20%, up to about 25%, up to about 30%, up to about 40%, or up to about 50% (where the percentages indicate void volume within the electrode). Equivalently, the porous electrode may have a density of at least about 50%, and up to about 70%, up to about 75%, up to about 80%, up to about 85%, up to about 90%, or up to about 95%, where the density is the amount of non-void volume present within the electrode material. In some cases, the porous electrode may have an average pore size of less than about 300 micrometers, for example, less than about 100 micrometers, between about 1 micrometer and about 300 micrometers, between about 50 micrometers and about 200 micrometers, or between about 100 micrometers and about 200 micrometers. The average pore size may be determined, for example, from density measurements, from optical and/or electron microscopy images, or from porosimetry, e.g., by the intrusion of a non-wetting liquid (often mercury) at high pressure into the material, and is usually taken as the number average size of the pores present in the material. Such techniques for determining porosity of a sample are known to those of ordinary skill in the art. For example, porosimetry measurements can be used to determine the average pore size of the porosity that is open to the exterior of the material based on the pressure needed to force a liquid, such as mercury, into the pores of the sample. In some embodiments, some or all of the porosity is open porosity, for example to facilitate filling of the pores by electrolyte. Techniques for forming a porous electrode are discussed in detail below.

Without wishing to be bound by any theory, it is believed that the pores facilitate transport of Li⁺ or other ions from the electrode to the electrolyte. In a material having a porous structure, some of which pores may be filled with an electrolyte (such as described below), Li⁺ or other ions have a shorter distance to travel from the electrode to the electrolyte and vice versa, thereby increasing the ability of the electrode to participate in energy storage, and/or increasing the energy density of the electrode. In addition, as discussed below, in some embodiments, porous electrodes may be fabricated that have a relatively low dimensional strain upon charge and discharge, and such materials can withstand a surprising number of charging or discharging cycles.

In some cases, the volume fraction porosity of the electrode is not constant throughout the electrode, but can vary. For example, the porosity of the surface of the electrode may be lower than the bulk of the electrode, one end of the electrode may have a higher or lower porosity than another end of the electrode, etc. In one embodiment, the surface is nonporous, although the bulk of the electrode is porous. In some cases, porosity differences in an electrode may be created during the process of creating the porous electrode, e.g., during the firing of a powder compact to form a ceramic. However, in other cases, the porosity differences may be intentionally controlled or altered, for example, by laser treatment of the surface, rapid thermal annealing of the ceramic, physical vapor or chemical vapor deposition, by adding particles or other materials to the electrode surface, by coating the electrode with a material, such as a sol-gel material, or the like. The porosity at the surface and variation in porosity with distance from the surface are readily observed and quantified using techniques such as electron microscopy and image analysis of the plan and cross-sectional views of the sample.

Electrodes such as those described above (e.g., porous, having protrusions and/or walls, etc.) may be formed, according to another aspect of the present invention, from a ceramic or ceramic composite. A ceramic is typically an inorganic non-metal material, although the ceramic can include metal ions within its structure, e.g., transition metals or alkali ions such as Li⁺ or Na⁺ or K⁺, as discussed below. A ceramic composite is typically a mixture including one or more ceramic materials, e.g. a mixture of different ceramic phases, or a mixture of a ceramic and a metal or a ceramic and a polymer, and may have improved properties compared to the ceramic alone. For example, a ceramic-ceramic composite may have an ion storage ceramic combined with a fast-ion conducting ceramic to impart higher ionic conductivity to the composite while still retaining ion storage functions. A ceramic-metal composite may have improved electronic conductivity and improved mechanical strength or fracture toughness compare to a pure ceramic. A ceramic-polymer composite may have improved ionic conductivity if the polymer is an electrolyte having higher ionic conductivity than the ceramic, as well as improved fracture toughness or strength. Combinations of these and/or other composites are also contemplated. In some embodiments, the electrode consists essentially of a ceramic, and in some cases, the electrode is formed from a unitary ceramic material. In some embodiments, the electrode material having the lower electronic conductivity is formed from a unitary ceramic or ceramic composite, which may improve electron transport to and from the electrode during use of the battery.

Non-limiting examples of suitable ceramic materials include those which are able to transport Li ions during charging/discharging. The ceramic may be one in which Li ions can be removed during charging (a “Li-extraction” ceramic), i.e., the ceramic is one that contains Li ions that can be removed to form a limiting composition material (e.g., Li ions can be extracted from LiCoO₂ to produce Li_{0.5}CoO₂, from LiNiO₂ to produce Li_{0.3}NiO₂, etc.). Examples of potentially suitable ceramic materials comprising Li include, but are not limited to, LiCoO₂, LiNiO₂, LiFePO₄, LiMnO₂, LiMn₂O₄, Li₂MnNiO₄, spinel, olivines, LiMPO₄, where M may comprise one or more of Ni, Co, Mn, and Fe, and may include transition metal or non-transition metal dopants substituted on the Li or M site, Li₄Ti₅O₁₂, or the like. In some cases, as discussed below, the ceramic has a linear strain differential during the insertion and removal of an ion of less than about 2%. Examples of such ceramics include LiCoO₂ and LiNiO₂.

Generally, the electrode may be formed out of a single, unitary “block” of ceramic, e.g., by “carving” the ceramic in some fashion, for instance, through micromachining or etching techniques or the like, to produce the final shape of the electrode. During such processes, portions of the unitary starting material are removed in some fashion, to produce the final shape of the electrode. Thus, the unitary starting material is of a size larger than the final electrode that is “carved” from the starting material. As discussed below, such unitary ceramic materials may have several advantages, including smaller strain differentials, lack of stress-concentrating features, or the lack of joints or seams by which ions, fluids, or gases could pass through. As used herein, the term “unitary” is not meant to include structures, such as conjoined individual particles, that are formed as separate, individual units which are then agglomerated together in some fashion to form the final structure; instead, a unitary material is one that is processed (e.g., by sintering) such that any individual particles used to form the material cease to be readily separable as individual particles.

For example, a unitary material may be formed from a ceramic precursor, e.g., a powder, through a sintering process. For example, the ceramic precursor may be pressed and/or heated such that the powder particles are bonded together, forming a unitary whole. Porosity may be created within the sintered ceramic material, for example, by controlling the initial powder packing density, the firing temperature and time, rate of heating during various stages of the firing process, and the firing atmosphere. Methods to control the shrinkage (densification) and evolution of porosity in powder-based materials to create a desired density or porosity are known to those of ordinary skill in the art.

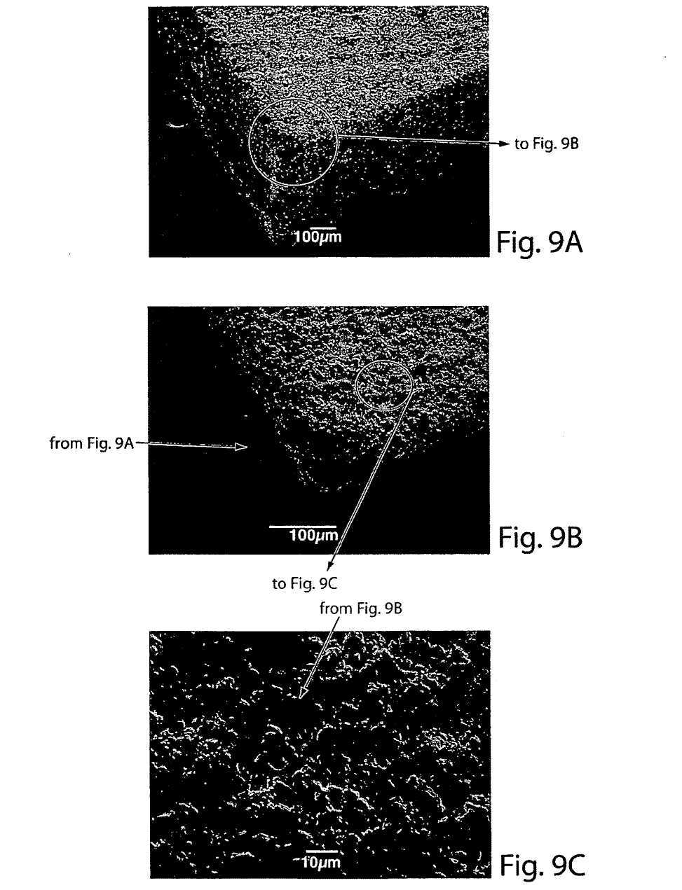

In one set of embodiments, the electrode is fabricated from a ceramic material having a linear strain differential of less than about 2%, or a linear strain differential of less than about 1%, when the electrode is infiltrated with Li ions. Non-limiting examples of such materials include LiCoO₂ (having a linear strain differential of about +0.6% upon delithiating to a composition of about Li_{0.5}CoO₂) and LiNiO₂ (having a linear strain differential of about −0.9% upon delithiating to a composition of about Li_{0.3}NiO₂). Such a material may be able to withstand a relatively large number of charging or discharging cycles while remaining free of cracks or otherwise degrading, as the material does not expand or contract significantly during charging or discharging. Linear strain is generally defined as the change in length of a material with respect to the initial length (ΔL/L₀). For example, a material of the instant invention may be able to withstand at least 6 cycles, at least 10 cycles, at least 15 cycles, or at least 20 cycles of complete charging and discharging (e.g., at a C/20 rate), while remaining free of identifiable cracks or other degradations (e.g., chips, peeling, etc.) that can be observed under scanning electron microscopy. As an example, in FIGS. 9A-9C, a ceramic material used as an electrode was fully charged and discharged (i.e., “cycled”) at a C/20 rate 6 times, and then studied using scanning electron microscopy (SEM). Thus, in another set of embodiments, the electrode is able to retain at least 50% of its initial storage capacity after at least 6 charge-discharge cycles at a C/20 rate. As can be seen in these figures (at different magnifications, as shown by the scale bars), no obvious degradation or cracking of the ceramic material was observed. In contrast, many prior art materials are unable to withstand such conditions.

In some embodiments, a porous electrode of the present invention may contain an electrolyte within the pores of the porous electrode. The electrolyte, in some cases, may be a liquid electrolyte, such as a mixture of alkyl carbonates and a lithium salt such as LiPF₆, or a polymer electrolyte, such as polyethylene oxide or a block copolymer. In some cases, each may contain a lithium salt to impart lithium ion conductivity. Formulations for such electrolytes, including additives to improve safety, cycle life, and/or calendar life amongst other attributes, are known to those skilled in the art, and it should be understood that any such formulation may be used, based on the desired attributes of the battery for a particular application. The electrolyte contained within the electrode may or may not have the same concentration or composition as the electrolyte that separates the electrode from an opposite electrode (i.e., separating the cathode and the anode within a battery). A liquid electrolyte may be useful, for example, to facilitate flow of Li ions into and out of the porous electrode. In some cases, the liquid electrolyte may comprise Li ions. An example of such an electrolyte is one using LiPF₆ as the lithium salt. Depending on the porosity of the electrode, the liquid electrolyte may be introduced into the pores of the electrode by exposing the pores to the liquid electrolyte, for instance, as discussed below. The electrolyte, in some cases, may also surround the protrusions of the electrode (if protrusions are present). For example, the electrolyte may be contained within the electrode (e.g., within walls of an electrode, if a wall is present), bathing the protrusions in electrolyte.

Another aspect of the present invention is directed to an electrolyte. The anode and the cathode in a battery or other electrochemical device are generally electronically insulated from each other while having an electrolyte to permit ion exchange. Although a porous “separator” material that is infused with an ion-conducting electrolyte can serve this function, according to one set of embodiments, the electrolyte is nonporous (i.e., solid), i.e., the electrolyte does not contain “pinholes” or defects (such as pores or cracks) through which Li dendrite formation leading to short circuits can occur, even after tens, hundreds, or thousands of cycles of charging or discharging. In some cases, the electrolyte comprises Li ions, which may be useful, to facilitate flow of Li ions into and out of the adjacent electrodes. Amongst numerous possible choices, one example of such an electrolyte is Lipon (lithium phosphorus oxynitride), an inorganic material typically made in thin-film form by sputtering. Another example of an electrolyte is lithium iodide (LiI). In one set of embodiments, the electrolyte is present as a film, which can be deposited by sputtering or other physical vapor or chemical vapor methods. In some cases, the electrolyte is a conformal film formed upon the electrode surface using layer-by-layer deposition, i.e., where discrete molecular layers of electrolyte material are added to the electrode until a suitably thick layer of electrolyte has been built up. Those of ordinary skill in the art will be aware of suitable layer-by-layer deposition techniques, which typically involve the application of molecular layers that alternate in their charge from wet chemical solution.

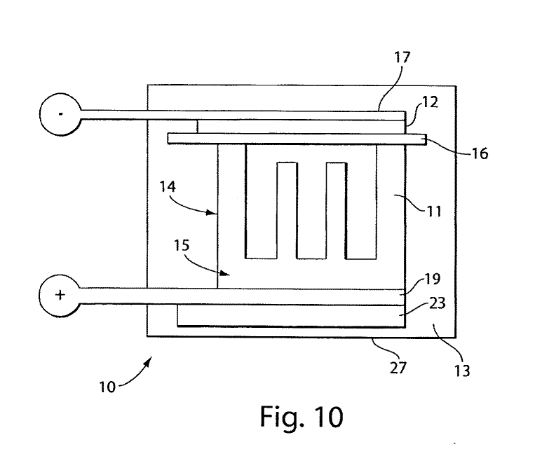

The nonporous electrolyte may be used, in some embodiments, to seal the electrode surface, e.g., coming into contact with the walls of the electrode, if present (for instance, forming a “capping layer” on the walls), thereby creating a hermetically sealed compartment containing the electrolyte containing an internal electrolyte, such as a liquid or a polymer electrolyte, within the electrode compartment. Thus, the hermetically sealed compartment may be defined by the walls, the base of the electrode, and the lid formed by the nonporous electrode. A non-limiting example of a battery having such a nonporous electrolyte is shown in FIG. 10. The nonporous electrolyte may have any suitable size and/or shape. For example, portions of the electrolyte may extend into the interior space of the electrode, or the electrolyte may essentially define a substantially planar layer or “lid” above the walls of the electrode. For instance, the nonporous electrolyte may have a thickness of at least about 1 micrometer, at least about 3 micrometers, at least about 5 micrometers, at least about 10 micrometers, at least about 20 micrometers, at least about 30 micrometers, at least about 50 micrometers, etc.

Yet another aspect of the invention is directed to techniques for making such electrodes and batteries or microbatteries. In one set of embodiments, a unitary ceramic material is used, and in some, but not all embodiments, the material may be etched in some fashion, for example, using micromachining techniques such as laser micromachining, or dry etching or wet chemical etching methods well known to those skilled in the art of fabricating microelectromechanical systems (MEMS). Such machining processes may be used to form the walls and/or protrusions on the surface of the base of the electrode. In another set of embodiments, the protrusions or walls of the electrode are produced directly by forming a starting powder or composite mixture under pressure using a die having the inverse of the desired final geometry. The electrode thus formed may be used directly or may be sintered after forming.

A non-limiting example of a completed battery can be seen in FIG. 10. In this figure, a battery 10 of the present invention includes a cathode 14, and a plurality of protrusions 18 that extend away from the surface of a base 15 of the cathode, surrounded by a wall 11. In addition, the battery may be contained within a packaging material 27, as is shown in FIG. 10. Several packaging materials for batteries are known to those skilled in the art. For lithium batteries, non-limiting examples include polymers, polymer-metal laminates, thin-walled metal containers (e.g., copper), metal containers sealed with polymers, and laser-welded metal containers. Other examples include a metallized liquid crystal polymer (LCP), a gold-free metallized liquid crystal polymer, copper, and/or Al₂O₃. For the batteries of the invention, one embodiment uses inorganic compounds such as insulating oxides as the packaging material. Such compounds may be applied by physical vapor deposition or coating from wet chemical solutions or particle suspensions.

In some cases, the components that are in electronic contact with the positive electrode or cathode are selected to be stable at the positive electrode potential during use. Certain materials can be used for such components are known to those skilled in the art. For example, aluminum, gold, and titanium are materials that are electrochemically stable when used with typical liquid electrolytes based on alkyl carbonates at the positive potential of cathode-active materials such as LiCoO₂, LiMn₂O₄, LiFePO₄, LiMnPO₄, and other cathodes of similar lithium insertion voltage in the range 2.5 V to 5 V.

Various components can also be used for the negative electrode or anode side. For example, copper, carbonaceous electrodes including graphite and hard carbons, metal alloy negative electrodes, or other lithium storage materials with a lithium reaction potential that is below about 1 V vs. lithium metal can be used in various embodiments.

One non-limiting example of a packaging material follows. A battery such as is shown in FIG. 1C may be contained within a copper metal package or “can,” for instance, a five-sided copper metal can with a seal flange at its open end, which may be covered by a polymer film. Other metals may be used instead of, or in addition, to copper, for instance, gold, nickel, and/or aluminum (or any combination of copper, gold, nickel, aluminum, and/or other materials). The cover may also comprise other insulating materials such as ceramics (including alumina) or glasses. For example, single crystalline sapphire may be used in some cases as a cover. As another example, the can may comprise gold on nickel and/or copper, or be replated with gold in some cases. At least a portion (or substantially all) of the polymer film may be metallized, e.g., to provide a suitable contact for an electrode, e.g., as is discussed below. In some cases, the metallization may include filling with metal of a via drilled into the insulating film to provide a conduit for electron flow between the two sides of the insulating film, as discussed below. The metallization may also include a ring of a solder metal or alloy deposited near the periphery of the insulating cover to act as an adhesive sealant for the joining of the can to the cover. In some cases, the metallization layer may comprise a solder or a solder alloy, e.g., solders comprising indium, tin, silver, gallium, or any combination of these and/or other materials.

As another example, lithium titanate spinel, which has a potential of 1.55 V vs. lithium metal, may be used with aluminum as a packaging material. As other examples, electrically insulating packaging materials such as polymers or inorganic glasses or oxides such as silica, alumina, magnesia, are stable in contact with either the positive or negative electrode active material. Material used for sealing the cells, and to attach components such as the electrodes or separators to the can or lid of the package, may be selected in similar manner in some cases.

The cover may be attached to the “can” by any suitable technique, for example reflow soldering, lead-tin solder, cyanoacrylates, epoxies (e.g., Rflex 1000), UV-curing adhesives (e.g., Locktite 3972 acrylic), solid sheet epoxies, and/or aluminum-gold reaction bonding. In one embodiment, gold “bumps” or individual deposits are used.

As an example, in one embodiment, the cathode and the metal can may be attached to aluminum using a paste made of PVDF (polyvinylidene difluoride) and carbon.

In certain embodiments, standard electrochemical tests including cyclic voltammetry may be conducted to determine the stability of the packaging material, adhesive, or sealant. For example, the electrochemical stability of materials that are on the cathode side including the can and/or the light-curing adhesive can be tested using cyclic voltammetry at 0.1 mV/s from 2.5 V to 4.75 V.

Non-limiting examples of such packages are shown in FIGS. 17A and 17B. In FIG. 17, package 27 includes a 5-sided bottom portion 31, e.g., comprising copper, and a top portion 33. Top portion 33 may be, for instance, a polymer film such as a liquid crystal polymer (e.g., a partially crystalline aromatic polyester), or a polyimide based material, such as Kapton or Upilex. In FIG. 17A, only a portion 34 of top portion 33 is metallized, while in FIG. 17B, substantially all of top portion 33 is metallized to provide a suitable contact for an electrode. FIG. 17B also shows tabs 35, which may be used to make connections to the cathode through package 27. Top portion 33 may also be any suitable substrate which can be metallized, for example, using interdiffusion or ultrasonic bonding. For example, top portion 33 may be a substrate that includes metals (e.g., copper or nickel), glass, a ceramic, or the like.

Package 27 may be made using any suitable technique, and in some cases, package 27 may be unitary. In one embodiment, package 20 is prepared by electroplating a mold, e.g., using electroformation or any other suitable technique. In some cases, additional materials may be added to package 27. For instance, in one embodiment, at least a portion of package 27 may be electroplated by other materials or metals, for example nickel or gold, which may be used as electrode contacts.

Other examples of electrode attachment mechanisms that could be used with the present invention include, but are not limited to, titanium/lead-tin solder, aluminum/gold reaction bonding, welding, or PVDF (polyvinylidene difluoride) and/or carbon. Still other methods include heat, pressure, light (infrared, ultraviolet, or visible) on solid or liquid adhesives or other sealing materials.

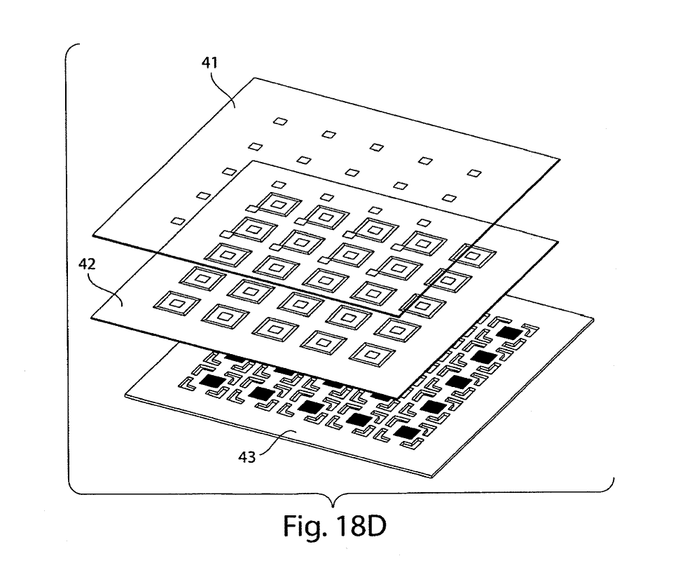

One non-limiting example of a fabrication technique will now be described. Referring now to FIG. 18, in FIG. 18A, a drop of solder 37 is placed in an empty metal “can,” then the battery 20 is added, as is shown in FIG. 18B. The assembly is reflow soldered on a hot plate, and preforms of lithium metal 38 are placed on top in FIG. 18C. The lithium may be melted or hot pressed to bring it into intimate contact with battery 20. Polymer covers may be prepared where the bottom surface of the cover is pretinned with solder. In some cases, as is shown in FIG. 18D, an array of polymer covers 42 may be aligned with an array of batteries 43 and a glass mask 41. Several fabrication methods such as electroforming and stamping exist to allow efficient production of arrays of covers and cans; by bonding such arrays, parallel sealing of large numbers of batteries in a single step can be achieved. The mask may be used to press the cover into contact and/or to control the temperature of the battery during sealing. The batteries may be sealed (e.g., hermetically) by clamping together the aligned layers as shown in FIG. 18D, and heating the assembly to reflow the solder. The heat required for the sealing process can be supplied by contact with a heat source as well as by radiative heating (e.g. using a flash lamp or heat lamp). If heat-sensitive components are being sealed inside the battery, external surfaces of the battery may be cooled or shielded from the heat source. As one example, a fixture holding an array of cans can also be designed to function as a heat sink, actively cooled if necessary. As another example, e.g., in the case of heating by radiative heating, reflective features such as metallization 45 on the glass mask may be used to limit heating of the battery. The approaches described here for controlled heating of solder can also be adopted for other heat-activated sealants such as solid sheets of curable epoxy or multilayered metallic structures that react at elevated temperature to allow reaction bonding of adjoining parts.

The cathode may be laser-micromachined, and has a size of about 500 micrometers in this particular example shown in FIG. 10. The cathode is in electrical communication with a current collector 19, such as a gold current collector, which in turn is positioned on a substrate 23, for instance, an alumina substrate. The collector may have any suitable thickness, for example, about 25 micrometers, about 50 micrometers, about 75 micrometers, about 100 micrometers, etc. Similarly, the base may have any suitable shape and/or dimensions, depending on the cathode. For instance, the base may have a thickness of at least about 0.5 mm, at least about 0.75 mm, at least about 1 mm, at least about 2 mm, etc.

Within the walls of cathode 15, which may be porous, is a liquid electrolyte 13, for example 1.33 M of LiPF₆ dissolved in a mixture of organic carbonates. The liquid electrolyte is contained within the electrode via a nonporous electrolyte 16, for example, a polymeric electrolyte. The nonporous electrolyte may also conformally cover the surfaces of cathode 15. The nonporous electrolyte may be able to conduct electrons and/or ions back and forth between the cathode and the anode, and may have any suitable thickness or shape, for example, a thickness of at least about 1 micrometer, at least about 3 micrometers, at least about 5 micrometers, at least about 10 micrometers, at least about 20 micrometers, at least about 30 micrometers, at least about 50 micrometers, etc.

In this example, the anode 12, positioned adjacent to the nonporous electrode, is in electrical communication with an anode current collector 17, such as a metal current collector (e.g., Cu). The anode may comprise, e.g., lithium and/or carbon, and/or other materials as described herein. The anode current collector may have any suitable thickness, for example, at least about 1 micrometer, at least about 3 micrometers, at least about 5 micrometers, at least about 10 micrometers, at least about 25 micrometers, at least about 50 micrometers, at least about 75 micrometers, at least about 100 micrometers, etc., and may or may not be the same thickness and/or comprise the same materials as the cathode current collector, depending on the embodiment and the application. In instances where nonporous electrolyte 16 conformally coats the surface of electrode 15, anode 12 may also conformally coat the film of electrolyte 16 in some cases, or may fill the space between the protrusions of electrode 15 while remaining everywhere separated from the electrode 15 by the electrolyte 16 in certain embodiments.

In some embodiments the electrode 15 is the initial source of the alkali ions that are stored in the electrodes during charge and discharge, and no anode is used, but simply a negative current collector. In some cases, the alkali ions, such as lithium, are deposited at the negative current collector as alkali metal upon charging of the battery, and are removed and deposited in the positive electrode upon discharge. As mentioned above, the ceramic may be formed, for example, by sintering particles together, e.g., forming a unitary material. Techniques for sintering particles to form a ceramic are known to those of ordinary skill in the art, e.g., forming a sintered ceramic by pressing and/or heating a precursor to form the ceramic. In one set of embodiments, such sintering may be used to form a porous unitary structure. As discussed, porosity may be created within the sintered ceramic material, for example, by controlling the sintering temperature and pressure, and such process conditions can be optimized to create a desired density or porosity using routine optimization techniques known to those of ordinary skill in the art.

The desired shape of the electrode may be fashioned using micromachining techniques such as laser micromachining. Those of ordinary skill in the art will be familiar with such techniques. For instance, in laser micromachining, a laser is directed at the unitary ceramic material. The laser light, when interacting with the ceramic material, may melt, ablate, or vaporize the material, which may be used to control the shape of the final electrode. Thus, laser micromachining can produce an object having a desired shape by removing, in some fashion using a laser, everything that does not belong to the final shape. The laser may have any suitable frequency (wavelength) and/or power able to destroy or otherwise remove such ceramic materials in order to produce the final structure for use in a battery or other electrochemical device.

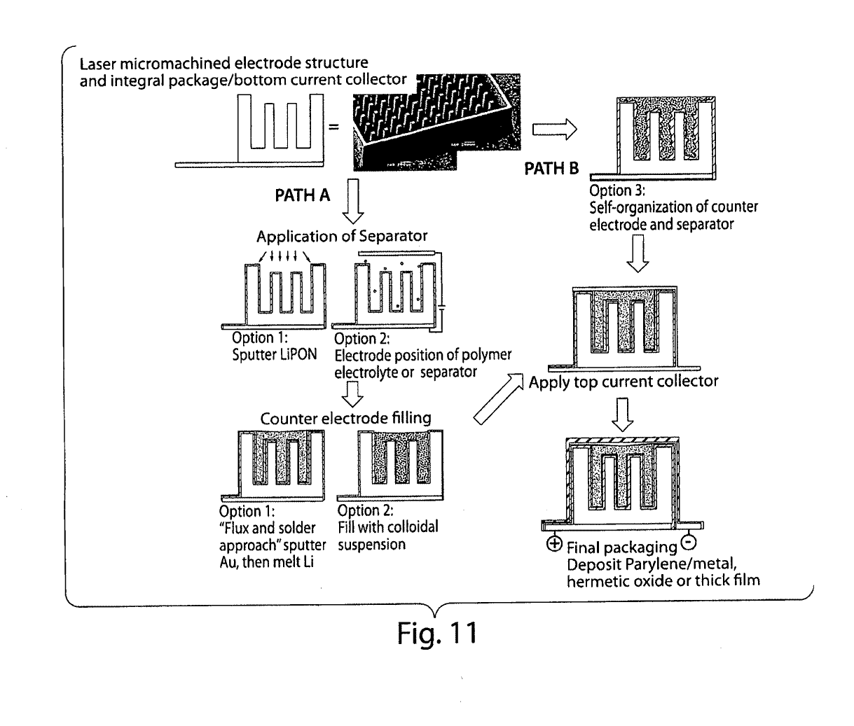

The following is a non-limiting example of a method of manufacturing an embodiment of the invention. Referring now to FIG. 11, in pathway A, the creation of a battery, which may be a microbattery, having a plurality of protrusions and a wall surrounding the plurality of protrusions, is shown. A unitary ceramic material is formed into an electrode having a plurality of protrusions and a wall surrounding the plurality of protrusions using techniques such as laser micromachining. The electrode may also contain a current collector, for instance comprising gold or another metal, such as silver. In one technique, a separator or electrolyte layer comprising Lipon and/or a polymer or organic electrolyte is first added to the electrode. As shown in FIG. 10, Lipon may be sputtered onto the electrode, or a polymer or organic separator may be deposited onto the electrode in some fashion, for instance, using coating from sol-gel solution, electrodeposition techniques, or layer-by-layer assembly.

Next, the counterelectrode is added to substantially fill the remaining space. In one technique, the interior space defined by the walls of the electrode is filled with a colloidal suspension, the colloidal particles being the negative electrode material and optionally additive particles such as conductive additives or binders. However, in another technique, a “flux and solder” approach is used, which Au is first sputtered onto the separator, then Li (e.g., Li solder) is melted onto the Au. Such a technique may be useful in cases where the electrode and/or the electrolyte contains a material that Li metal, when in a liquid state, will not “wet” or substantially adhere to. In such cases, gold or another compatible metal that Li will “wet” when Li is in a liquid state, is used to facilitate bonding. Without wishing to be bound by any theory, it is believed that Li is able to react with the metal to wet the surface. The top current collector (e.g., a metal, such as Cu, is then added, and optionally, the battery is sealed. The battery can then be packaged, e.g., by depositing parylene and/or a metal hermetic oxide or thick film onto the battery.

In another set of embodiments, a battery, such as a microbattery, having a plurality of protrusions and a wall surrounding the plurality of protrusions can be created as follows. Referring again to FIG. 10, in pathway B, the creation of a battery may proceed by allowing self-organization of the counter electrode and the separator to occur. In this approach, repulsive forces between the electrode and the counterelectrode are used to create a separation that is spontaneously filled by separator or electrolyte material. The repulsive forces used to self-organize the two electrodes with respect to each other include but are not limited to van der Waals forces, steric forces, acid-base interactions, and electrostatic forces. Subsequently, as before, a top current collector (e.g., a metal, such as Cu, is then added, and optionally, the battery is sealed). The battery can then be packaged, e.g., by depositing parylene and/or a metal hermetic oxide or thick film onto the battery.

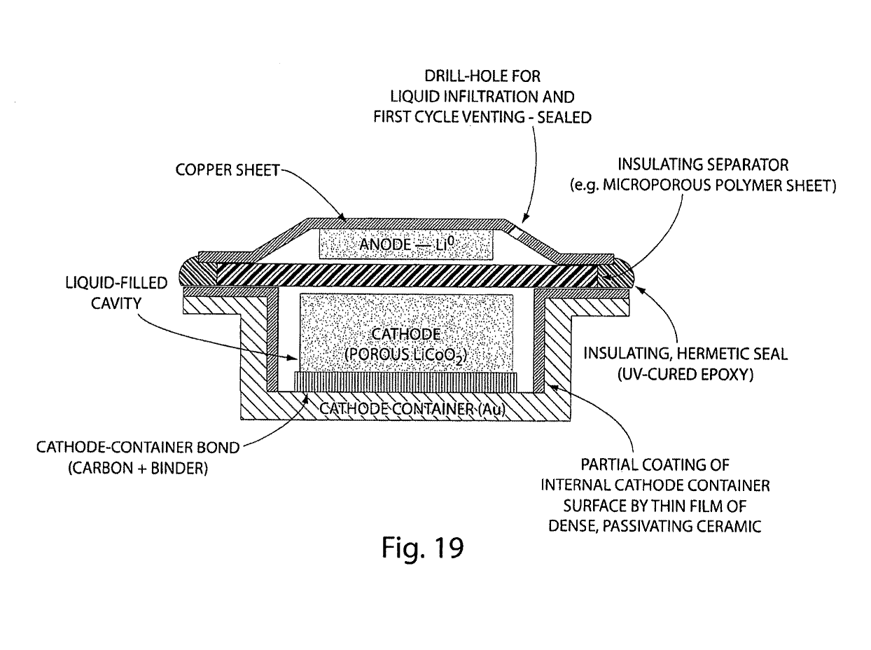

Additional examples are illustrated with reference to FIGS. 19-22. In FIG. 19, a gold cathode container is used to form a microbattery. The cathode is formed into a containing structure having a partial coating of a thin film of dense, passivating ceramic of lithium phosphorous oxynitride (LiPON). The cathode in this example is porous LiCoO₂, bonded using carbon and binder to the gold cathode container, and the remainder of the cavity filled with a liquid, such as the liquid electrolytes discussed above. The binder was prepared by adding carbon fibers (<2% by weight) into a concentrated solution of polyvinylidene fluoride in an organic solvent. Other materials may be used as well for the cathode.

The binder was prepared by mixing Kureha 7208 solution (31 parts by weight), vapor grown carbon fiber (2 parts by weight), and ECP (high surface area carbon black) (2 parts by weight). A small amount of the mixture was applied on one of the two surfaces to be bonded and the two surfaces pressed together gently. The binder was dried under air for at least one hour with no disturbance of the bonded parts. Further drying was performed under vacuum at temperatures higher than 60° C. and for at least 6 hours.

A solid electrolyte, such as those discussed above, separates the cathode compartment from the anode compartment. The anode compartment contains lithium in this example, although other anode materials can also be used. The anode compartment is contained within a “can” formed from copper, and the compartments are bound together using UV-cured epoxy in this example, forming an insulating, hermetic seal. One or both of the metal containers can be partially coated with insulators in some cases to minimize corrosion and/or shorting problems. A drill-hole can optionally be used for liquid infiltration (e.g., of a liquid electrolyte), venting, or the like (the drill-hole may also be sealed afterwards in some cases). In addition, although metals were used to form the containers for the anode and cathode in this example, this is by way of example only, and other materials, such as insulators (e.g., having appropriate metallization contacts and/or feedthroughs) can be used. For instance, one of the containers can be made of an insulator material with metallization, while the other container can be made of a metal. In some cases, the metallization layer on the insulator material can be used to facilitate bonding of the components, e.g., by interdiffusion or ultrasonic welding.

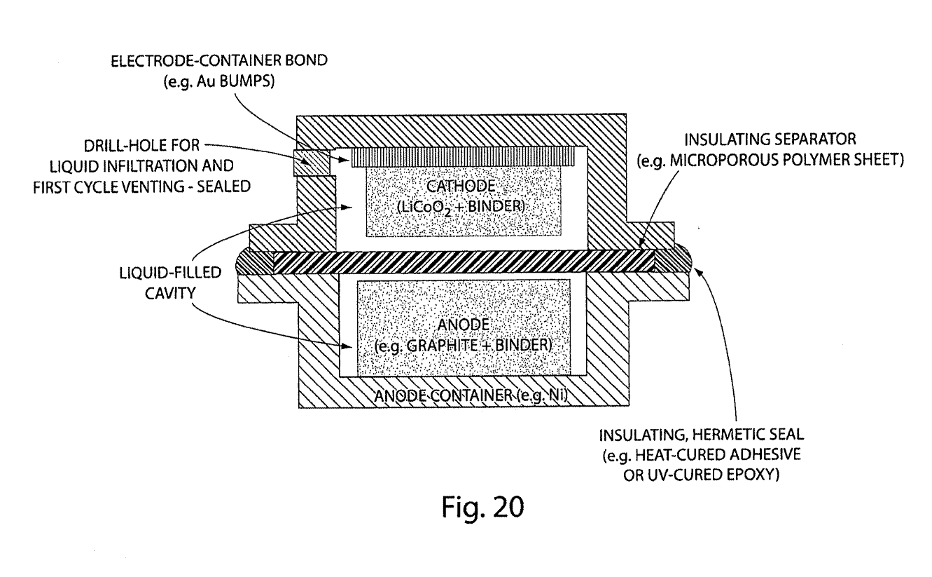

Another non-limiting example is illustrated in FIG. 20. In this example, nickel is used as the anode container, while gold-coated nickel is used as the cathode container. Both the anode and cathode compartments contain liquid electrolyte, which may be the same or different. In this example, the anode comprises graphite and binder, while the cathode comprises LiCoO₂ and binder, although other materials may be used for each of these in other embodiments. The cathode may be secured to the cathode container using any suitable technique, such as using gold “bumps” such as those disclosed herein. The compartments may be bound together using UV-cured epoxy or a heat-cured adhesive in this example, forming an insulating, hermetic seal.

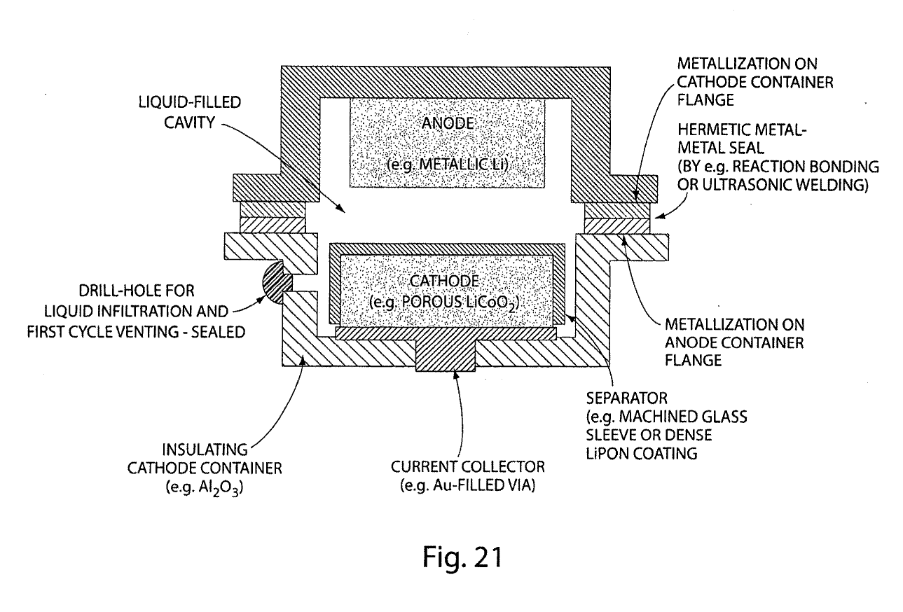

Yet another example is shown in FIG. 21. In this example, porous LiCoO₂ is used for the cathode and metallic lithium is used for the anode. Other materials may be used for the anode in other embodiments, for example, carbon. The cathode container in this example is insulating Al₂O₃ (although other insulators may also be used), with a gold-filled via used as a current collector for the cathode, which passes through the insulating container. A separator, such as a machined glass sleeve or a LiPON coating, may be positioned in contact with the cathode, as is shown in FIG. 21. The anode container in this example is copper, and the anode and cathode containers are bound using a hermetic metal-metal seal (e.g., using reaction bonding, ultrasonic welding, or the like). The cathode container flanges in this example may also be metallized to improve contact in some cases.

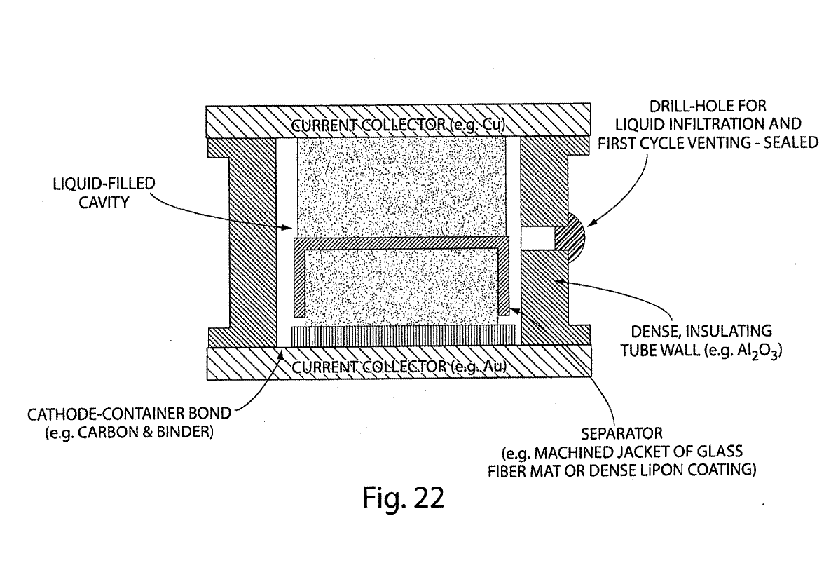

A “tube cell” is illustrated in FIG. 22 as another example. In this example, the anode comprises graphite and binder, while the cathode comprises porous LiCoO₂; the anode current collector may be copper and the cathode current collector may be gold. A separator, e.g., a machined glass sleeve, a UPON coating, a porous polymer, or the like, may be used to separate the anode from the cathode, while both are contained within a liquid electrolyte. Optionally, there may be a liquid gap on one or both sides of the separator as well. The walls surrounding the electrolyte are made of an insulator material, such as Al₂O₃. In one embodiment, the tube is formed from an insulating material and has an average wall thickness of less than 250 micrometers. For instance, the tube may be ceramic (e.g., Al₂O₃), glass, a hermetic cured polymer, or any other insulators discussed herein.

U.S. patent application Ser. No. 10/021,740, filed Oct. 22, 2001, entitled “Reticulated and Controlled Porosity Battery Structures,” by Chiang, et al., published as U.S. Patent Application Publication No. 2003/0082446 on May 1, 2003, and U.S. patent application Ser. No. 10/206,662, filed Jul. 26, 2002, entitled “Battery Structures, Self-Organizing Structures, and Related Methods,” by Chiang, et al., published as U.S. Patent Application Publication No. 2003/0099884 on May 29, 2003, are incorporated herein by reference. Also incorporated herein by reference are U.S. patent application Ser. No. 12/126,841, filed May 23, 2008, entitled “Batteries and Electrodes For Use Thereof,” by Chiang, et al.; International Patent Application No. PCT/US2008/006604, filed May 23, 2008, entitled “Batteries and Electrodes For Use Thereof,” by Chiang, et al.; and U.S. patent application Ser. No. 12/323,983, filed on Nov. 26, 2008, entitled “Batteries and Electrodes For Use Thereof,” by Chiang, et al. Also incorporated herein by reference are U.S. Patent Application Ser. No. 61/027,842, filed Feb. 12, 2008, entitled “Small Scale Batteries and Electrodes For Use Thereof,” by Marinis, et al.; and U.S. Provisional Patent Application Ser. No. 61/118,122, filed Nov. 26, 2008, entitled “Small Scale Batteries and Electrodes For Use Thereof,” by Marinis, et al.

The following examples are intended to illustrate certain embodiments of the present invention, but do not exemplify the full scope of the invention.

### Example 1

This example illustrates an integrally packaged, solid-state lithium rechargeable microbattery with a 3-dimensional interpenetrating-electrode internal architecture, in accordance with one embodiment of the invention. Such microbatteries may have the capability for outer package aspect ratios of (for example) less than 5:1 for maximum to minimum dimensions (i.e., not restricted to thin planar configurations), active materials packaging fraction of >75% in a 1 mm³ volume, under which conditions they will exceed an initial energy density target of 350 W h/l by a factor of 2 to 4. The approach in this example will use currently available and proven cathode and anode materials, but does not exclude higher energy or higher rate active materials in the future.

The microbatteries in this example will allow energy densities of about 350 W h/l to about 1500 W h/L to be achieved, depending on the electrochemical couple used, and specific design parameters, as discussed below. Microbatteries of this form could be used to power a wide variety of small systems from simple sensors to systems with integrated ultrahigh density packaging.

The technical approach is founded on a microfabricated structure of 3D electrode arrays co-fabricated with an integral hermetic package, e.g., as is illustrated in FIGS. 6A-6E. This particular demonstration uses graphite and laser micromachining as the fabrication method. Using highly-oriented pyrolytic graphite (HOPG) that was laser-machined to about 200 micrometer half-thickness, cycling rates of about C/20 were demonstrated in lithium half-cells. In graphite, a ten-fold increase in rate to 2 C would require a factor of 10^{1/2}=3.2 reduction in cross-sectional dimension (e.g., diffusion time t=x²/D, where x is the diffusion length and D the diffusion coefficient). These dimensions are achievable with laser micromachining technology. In order to maximize energy density, the electrode cross-sectional dimensions should be as large as possible while still supplying the desired rate capability (since the inactive materials fraction increases as the feature size decreases). In some microbattery applications, electrodes having micrometer to tens of micrometer dimensionality may be sufficient.

FIG. 6A shows that laser micromachining can produce individual electrode features in graphite having about 50 micrometer half-thickness and 0.5 mm height with a slight (controllable) taper, forming a 3 mm×3 mm array (4.5 mm³ volume). Furthermore, the lateral resolution and taper of the kerf in laser machining is strongly impacted by the thermal conductivity of the material being machined, with high thermal conductivity decreasing resolution and increasing taper. In lithium intercalation oxides of low thermal conductivity compared to graphite, it is expected that closely-spaced features of about 10 to about 20 micrometer total width to be possible at feature heights of about 0.5 mm to about 1 mm. In this example, 3-dimensional (3D) electrodes of similar morphology but having smaller cross-sections can be fabricated from lithium storage compounds, by laser-micromachining or other microfabrication processes, for example, amenable to simultaneous fabrication of many devices. These continuous and dense 3D electrode arrays can be fabricated from the active material of lower electronic conductivity, usually the cathode, in order to decrease electronic polarization and increase the rate capability of the final device.

Using the microfabricated electrode/package structures as the starting template, three example paths to fabrication of the completed battery are demonstrated, with reference to FIG. 11, as discussed below.

In one path, conformal deposition of a solid inorganic electrolyte film (e.g., Lipon) is performed by sputtering, which can create an electronically insulating layer of 1 micrometer to 3 micrometer thickness, which may cover the upward-facing surfaces. The taper of these electrode features can be “tuned” through instrumental parameters to allow conformal coating. At such thickness, the impedance of the electrolyte film during subsequent use as a battery may be low enough that the rate capability can be primarily determined by the electrodes. After electrolyte deposition, the remaining free volume within the cell can be filled by the counterelectrode. The counterelectrode will, in one instance, be Li or a Li alloy, melt-infiltrated (about 180° C.) into the coated electrode array using a “flux and solder” process to enable high surface tension liquid lithium to wet oxide surfaces, as discussed above. An advantage of using lithium metal is that its high volumetric capacity allows the negative electrode to be of small volume, for example only about one-fourth that of the positive electrode, if LiCoO₂ is used. Thus, a negative electrode film of only several micrometer dimensions filling the pore space of the electrode array may be needed for cell balancing. Alternatively, the counterelectrode can be applied in the form of a powder suspension where a solid polymer electrolyte (e.g., PEO-based) is included in the formulation to provide a fully solid-state device. Subsequently, a top current collector can be applied by physical vapor deposition or thick film paste technology, following which a hermetic sealing layer including a sputtered oxide or CVD-applied polymer layer (parylene) is used to complete the packaging.

In another path, similar to the path outlined above, the electrolyte film is an electrodeposited layer of a solid polymer electrolyte. Methods for the electrodeposition of electronically insulating polymer films can be applied in this project to form electrolytic layers. Alternatively, a layer-by-layer deposition approach may be used. The counterelectrode may be powder suspension based, since even the modest melting temperature of Li alloys could damage polymeric electrolytes. The subsequent packaging steps are similar as described above.

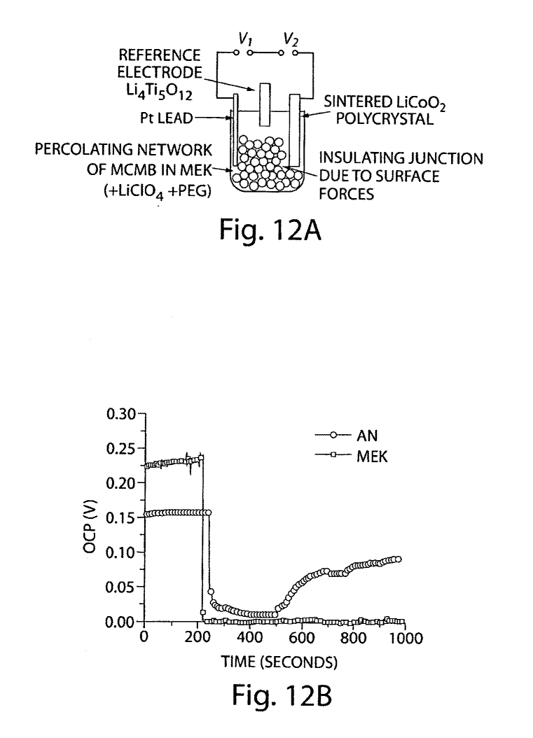

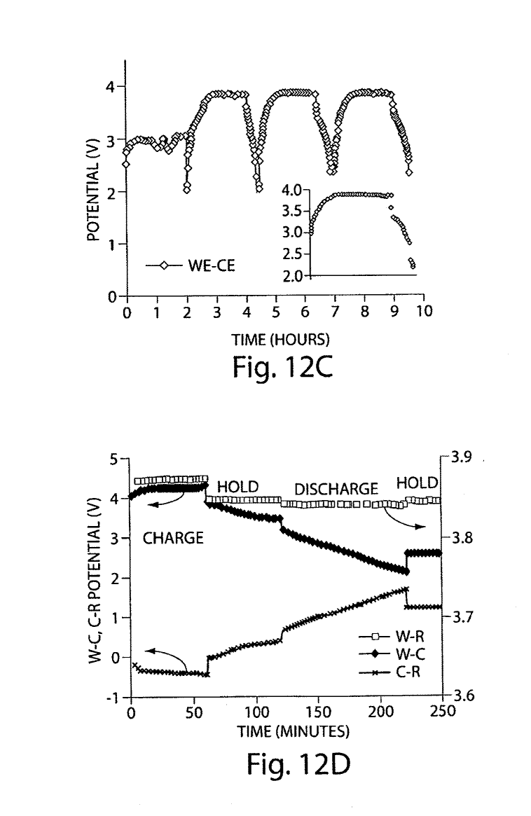

In yet another path, a colloidal-scale self-organization approach may be applied. LiCoO₂ and graphite immersed in a suitable solvent may be mutually repulsive due to short-range dispersion and electrostatic forces. FIGS. 12A-12D shows key results in which the mutual repulsion between sintered dense LiCoO₂ and an MCMB (mesocarbon microbead) suspension formed a rechargeable lithium battery under the influence of the surface forces. The constituents of solid polymer electrolytes were dissolved in the solvent without negatively affecting the interparticle forces. FIG. 12A shows a cell schematic. FIG. 12B shows the open circuit potential (OCP) between LiCoO₂ and MCMB upon forced contact, showing an electrical short-circuit upon contact for acetonitrile, but an open circuit for MEK (methyl ethyl ketone) due to repulsive surface forces. FIG. 12C shows reversible galvanostatic cycling of a self-organized battery using MEK and 0.1 M LiClO₄ as the electrolyte. FIG. 12D shows measurements of the potential difference between a Li titanate reference electrode and the LiCoO₂ working (W) and MCMB counter (C) electrodes, conducted in MEK and 0.1 M LiClO₄ and 1 wt % PEG 1500 (poly(ethylene glycol)). All potentials referenced to Li/Li⁺. Potentials observed during each stage of the test demonstrate Faradic activity, with the LiCoO₂ being delithiated and MCMB being lithiated. In the present configuration, an MCMB suspension can be used to fill the integral container formed from the LiCoO₂ and a self-forming separator obtained upon drying. Subsequent application of a top current collector and outer packaging will be carried out in the same manner as the above.

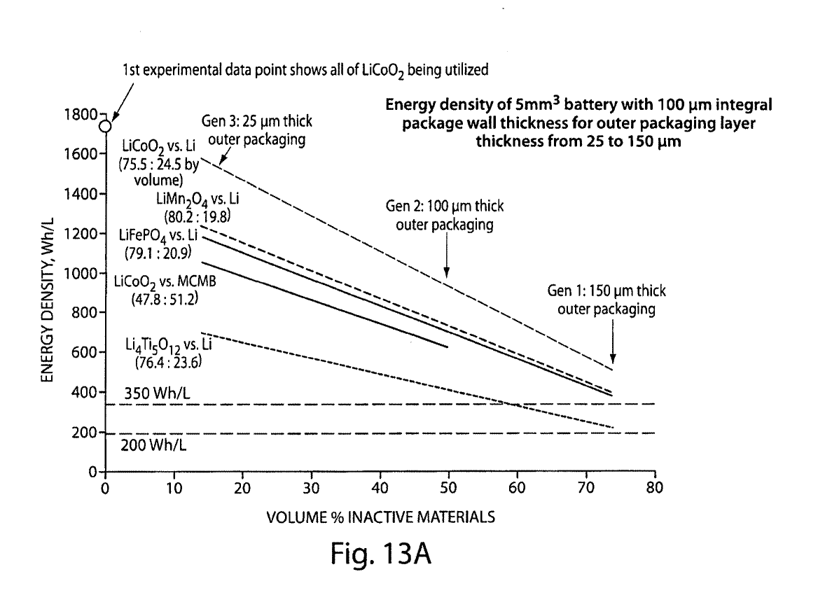

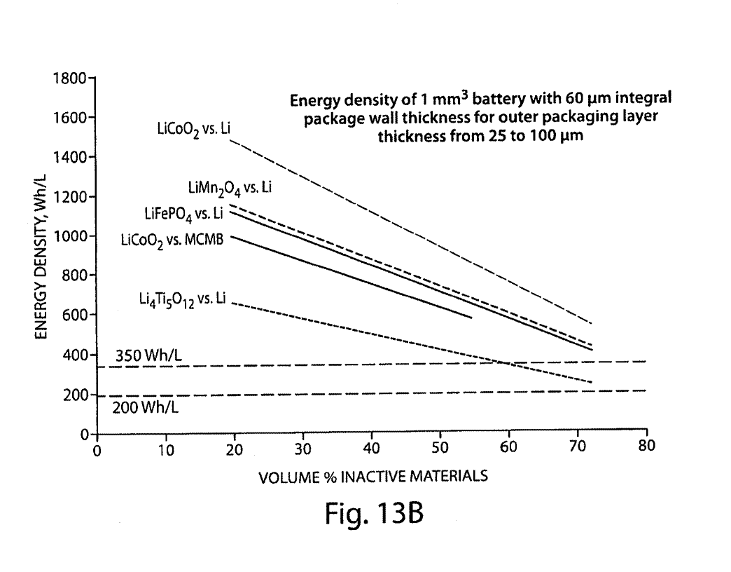

The energy densities are determined in these devices by the volume fraction of active materials present in the cell, and the degree of electrochemical utilization of those materials. In FIGS. 13A and 13B, plots of the expected energy density for microbatteries made from 5 different electrochemical couples using the present fabrication approach is plotted against the volume fraction of inactive material in the packaged cell due to the electrolyte layer, integral package wall, current collectors, and outer packaging for 5 mm³ (FIG. 13A) and 1 mm³ (FIG. 13B) volumes. In each case, the relative volumes of the positive and negative electrode are as needed for a charge-balanced cell. The theoretical energy density (at zero percent inactive material) of these systems exceeds 350 W h/L by a factor of 2.3 to 5. The results for 5 mm³ microbatteries of the configuration in this example are calculated assuming realistic component dimensions: 50 micrometer electrode diameter with 100 micrometer or 60 micrometer integral package wall thickness, 2 micrometer electrolyte layer thickness, and 10 micrometer thick current collectors. The thickness of the outer packaging is treated as a variable, ranging from 25 micrometer to 150 micrometer thickness. Also shown in FIG. 13A is an experimental data point (identified as 21), which illustrates that substantially all of the LiCoO₂ has been utilized.

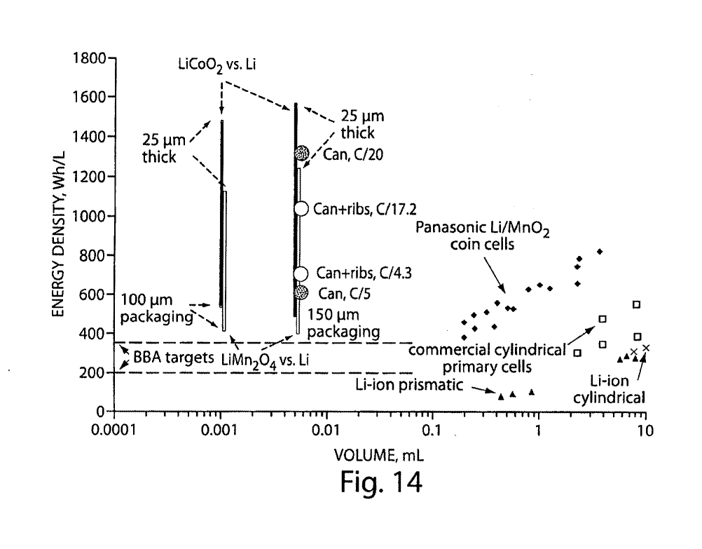

FIG. 14 compares the results in FIGS. 13A and 13B against recent data for commercially-available small batteries, as well as data for various embodiments of the invention at various discharge rates. Based on this figure, the performance envelope represented by this approach appears to represent a major improvement in the performance of small batteries.

### Example 2

In this example, 3D batteries having periodic or aperiodic interpenetrating electrodes are used since their electronic conductivity is typically higher than ionic conductivity in battery materials. Interpenetrating electrodes of high aspect ratio can have shorter ion diffusion length between electrodes while still taking advantage of the higher electronic conductivity along the electrodes to extract current. In the solid-state diffusion limit, the dimension that may determine the utilization of the battery capacity is the half-width x of the electrode features, for which the discharge time is t=x²/D_{Li}.

Using tabulated room-temperature lithium chemical diffusivities (D_{Li}) for spinel and layered structure intercalation oxides, which fall in the range 1×10⁻⁹ cm²/sec to 5×10⁻⁹ cm²/sec, for a maximum 2 C discharge rate (t=1800 sec), a half-thicknesses of about 6 to about 30 micrometers is useful. These kinetics and their limitations on particle dimensions are well-known to the battery field; LiCoO₂ is typically used as particles of 5 to 10 micrometers dimension, while LiMn₂O₄ has a higher and also isotropic lithium diffusion coefficient allowing roughly 25 micrometer particles to be used. LiFePO₄, on the other hand, has a much lower lithium diffusion coefficient requiring particle dimensions of <100 nm for high energy and power. Li₄Ti₅O₁₂ is similar to LiFePO₄ in this respect. Such materials may be used as fine-scale porous materials filled with suitable electrolytes. For LiCoO₂ and LiMn₂O₄, as well as related layered oxide and spinel compounds, a total electrode dimension of 10 micrometers to 30 micrometers may be desired. Also, for any reticulated structure, the smaller the feature size, the greater the inactive volume occupied by electrolyte/separators, binders and/or conductive additives. The results plotted in FIGS. 13 and 14 show that these materials, combined with a low lithium potential anode such as Li metal, Li alloys, or carbon-based electrodes, have desirable energy densities at the proposed electrode dimensions.

For non-planar form factors, a second issue in the fabrication of microbatteries is the electrode aspect ratio or feature height. While various lithography-based processes have been used recently to fabricate 3D electrodes, these experiments focus on laser micro-machining due to its suitability for fabricating highly aspected features with controlled taper. FIG. 4 illustrates these two geometric parameters, as well as the ability to design in controlled pore fraction for the counterelectrode. FIG. 4A shows 1.2 mm height at 200 micrometer to 250 micrometer feature width; FIGS. 4B and 4C illustrate the ability to control taper. As mentioned earlier, the spatial resolution of laser-micromachining can be determined by the thermal conductivity of the material. Preliminary laser-machining results on densified LiMn₂O₄ as one example indicates that it is possible to fabricate 3D electrodes having 5:1 to 20:1 aspect ratios at the cross-sectional dimensions desired.

Too high of an aspect ratio may be undesirable in some cases from the viewpoint of electronic polarization (voltage drop along the electrode), for example, in highly reticulated electrodes of thin cross-section. For LiCoO₂ and LiMn₂O₄ and related compositions, which have electronic conductivities >10⁻³ S/cm at room temperature, the voltage drop at these aspect ratios is negligible (<0.1 V).

While laser-machining with a single focused beam is one approach, resulting in individually fabricated devices, scale-up to fabrication methods capable of producing many simultaneous devices from an oxide “wafer” (e.g., produced by hot-pressing) is also possible. Laser-machining remains an option for scaleup, using diffuse beams and physical masks, for example. However, other methods used in MEMS fabrication such as deep reactive ion etching are also possible.

The electrolyte layer may be deposited using Lipon. Lipon is a thin film electrolyte, which at 1 micrometer to 2 micrometers thickness provides a low impedance, high rate, low self-discharge electrolyte. The fabricated 3D electrode structures can be sputtered with Lipon. The uniformity of Lipon coverage can be evaluated by electron microscopy and electrical tests after deposition of the counterelectrode.

An alternative to Lipon is the electrodeposition of solid polymer electrolytes (SPEs) such as PEO-based compositions, or a polyelectrolyte multilayer approach. Recent work on electrophoretically formed batteries shows that electrodeposition is an effective conformal deposition technique for PEO-based electrolytes. For typical room temperature conductivities of 10⁻⁵ skin to 10⁻⁴ S/cm, the electrolyte is not limiting, at a few micrometers thickness.

Selection and deposition of the counterelectrode may be performed as follows. 3D micromachined structures may be formed out of the positive electrode for electronic conductivity reasons discussed earlier. For the negative electrode that will fill the pore space after deposition of the electrolyte film, lithium metal, a lithium metal allow such as LiAl, or a graphite-based suspension can be used, with a cell structure designed to achieve cell balance. Graphite based anodes such as MCMB can be formulated similarly to conventional lithium ion anodes, except that in the absence of liquid electrolytes, SPE can be used as a binder phase. These suspensions can be used to infiltrate the pore space in the electrolyte-coated 3D structure.

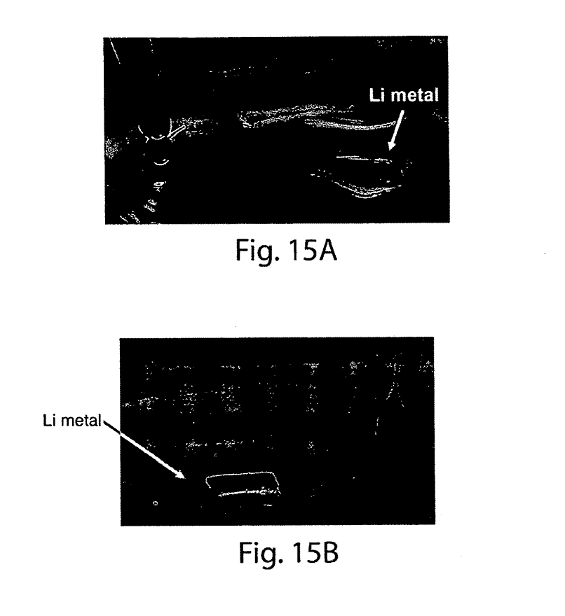

For the deposition of 0.5 mm to 1 mm thick lithium metal, given the low melting point (181° C.) of lithium metal, it would be attractive to use liquid metal infiltration to fill the 3D structure. A difficulty is that, like other liquid metals, lithium has a high surface tension and does not as easily wet oxides or polymers. Thus, a “flux and solder” method is used in this example, by which liquid lithium can be made to wet oxide surfaces. By first sputtering a thin layer of a metal that alloys with Li, such as Au, reactive wetting of the sputtered surface occur readily. This was demonstrated on glass surfaces, as shown in FIG. 15, with various configurations and various discharge rates. Thus, a sputtered metal layer applied to the electrolyte surface can be used to enable subsequent infiltration by lithium metal, filling the 3D electrode structure (FIG. 11). In order to control the amount of lithium metal that is deposited, the liquid lithium may be dispensed through a syringe or to dispense and then melt the solid lithium metal powder (SLMP) available from FMC corporation, which is passivated with a surface phosphate layer to allow handling in air and certain organic solvents.

Self-organization as an assembly method may also be used for selection and deposition of the counterelectrode. A colloidal-scale self-assembly method for bipolar-devices may be used in which repulsive forces between dissimilar materials are used to form electrochemical junctions at the same time that attractive forces between like material are used to form percolating conductive networks of a single electrode material. A demonstration of this approach is shown in FIG. 12, in which the percolating network is MCMB. The present 3D forms a dense and continuous 3D electrode from the less conductive material.

One of the challenges in microbattery technology, including thin-film batteries, has been the development of effective hermetic packaging with minimal contributed volume. The 3D design in this example uses densified oxide for hermetic sealing on all except the top surface (FIG. 11). Thus final sealing of the battery can be accomplished by deposition from the top of a suitable packaging material. A parylene-based packaging material, on top of which is typically sputtered a metal film for hermeticity may be used, or a dense insulating oxide coating by physical vapor methods may also be used.

### Example 3

In this example, it is shown that a porous sintered electrode of LiCoO₂ of greater than 0.5 mm minimum cross-sectional dimension that is infused with a liquid electrolyte can, surprisingly and unexpectedly, be electrochemically cycled while obtaining nearly all of the available ion storage capacity over at least 20 cycles at C/20 rate with minimal capacity fade and no apparent detrimental mechanical damage to the electrode. This shows that such electrodes can effectively be used in certain batteries of the invention.

A battery grade LiCoO₂ powder from Seimi Corporation (Japan) having 10.7 micrometers d₅₀ particle size was pressed and fired at 1100° C. in air to form a porous sintered ceramic having about 85% of the theoretical density of LiCoO₂. In one instance, a plate of this electrode having 0.66 mm thickness was prepared, as shown in FIGS. 8A and 8B. This electrode plate was attached to a gold foil current collector and assembled for testing in a sealed polymer pouch-cell, using lithium metal foil as the counterelectrode, a copper current collector at the negative electrode, a porous polymer separator of 20 micrometer thickness, and a liquid electrolyte having a 1.33 M concentration of LiPF₆ in a mixture of organic carbonates.

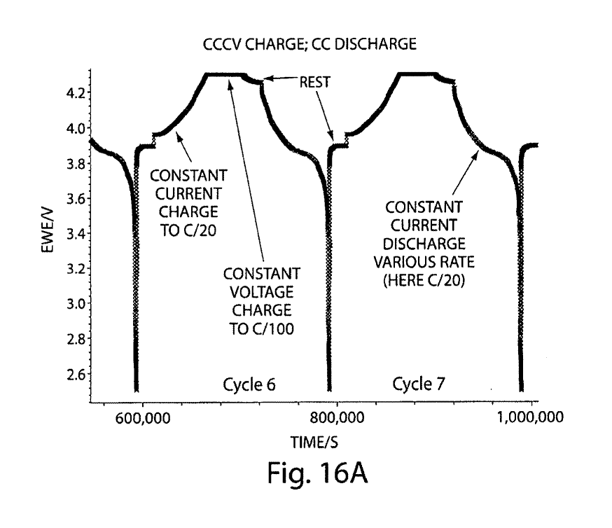

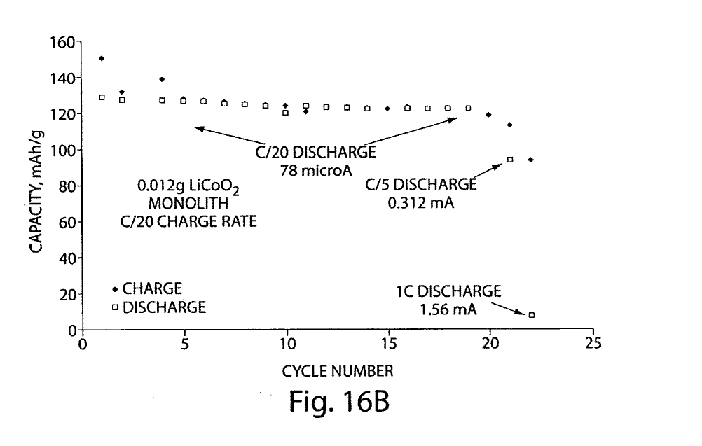

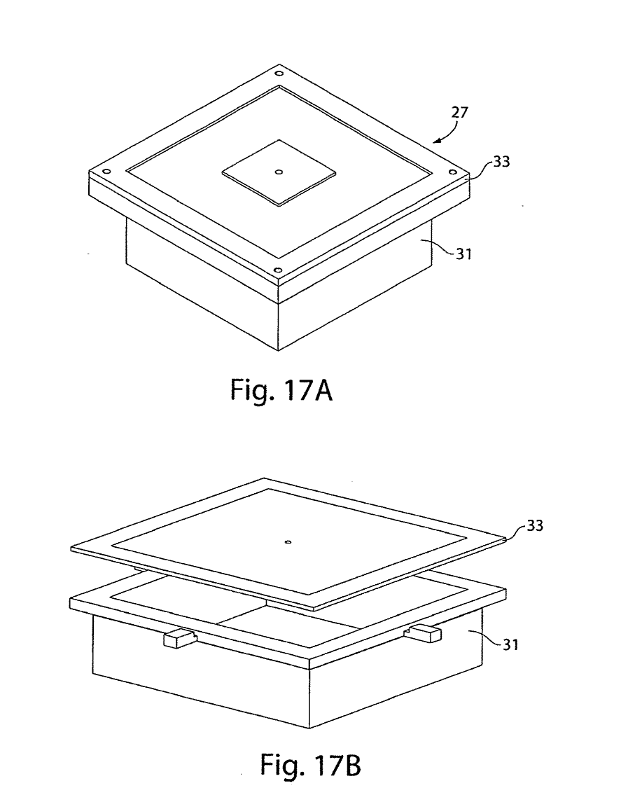

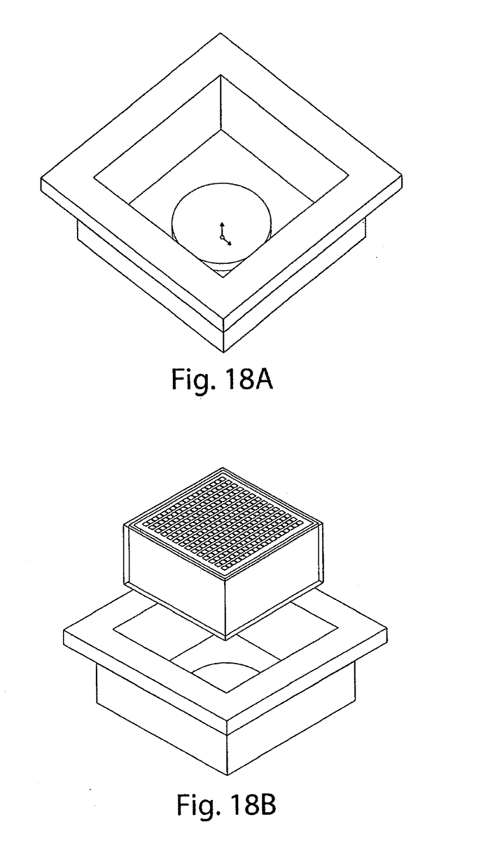

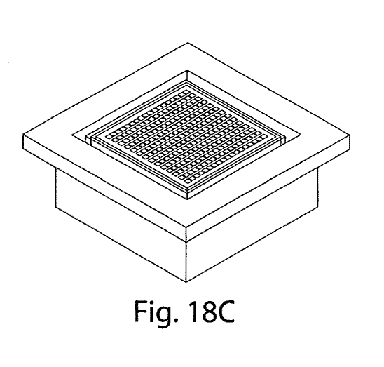

FIG. 16A shows the 6^{th} and 7^{th} charge-discharge cycles of this cell. The charge protocol used a constant current at C/20 rate to an upper voltage of 4.3 V, followed by a constant voltage hold until the current decayed to C/100 rate, followed by an open-circuit rest, followed by a constant current discharge to 2.5 V. FIG. 16B shows the charge and discharge capacities observed over 20 cycles at C/20 discharge rate, followed by discharges at C/5 and 1 C rate. The C/20 discharge capacity was about 130 mAh/g, essentially the same as the value observed for this LiCoO₂ over this voltage range in standardized tests. This shows that this porous electrode was able to accept and discharge nearly all of the lithium storage capacity at C/20 rate. Even at C/5 rate, the capacity was above 90 mAh/g. Furthermore, there was very little capacity fade over 20 cycles at C/20 rate. When this electrode is packaged as a complete microbattery according to the earlier described construction and methods, the volume is 6.4 mm³ and the projected energy density based on the measured cathode performance is 954 W h/L.

Remarkably, this sample was found to exhibit no apparent signs of mechanical failure after this electrochemical test, as shown in FIG. 9.

In other instances, the electrodes shown in FIGS. 2 and 7 were produced from the same starting sintered ceramic using laser micromachining, and were assembled into a test cell and electrochemically tested in the same manner. These test electrodes exhibited similar electrochemical performance to the electrode of FIG. 16. Based on the electrochemical tests of each of these electrodes, in fully packaged form, the electrode of FIG. 2 produces a battery of 5.72 mm³ volume and 1022 W h/L energy density, while the electrode of FIG. 7 produces a battery of 5.74 mm³ volume and 1300 W h/L.

### Example 4

In this example, it is shown that a battery can be made using a porous sintered electrode of LiCoO₂ infiltrated with a liquid electrolyte in a can-lid package.

A battery grade LiCoO₂ powder from Seimi Corporation (Japan) was ball-milled to a d₅₀ particle size of 5.7 micrometer. The powders was pressed and fired at 950° C. in air to form a porous sintered ceramic having about 75% of the theoretical density of LiCoO₂. The 0.4 mm thick electrode was attached to an electroformed gold can using PVDF and carbon binder and vacuum dried at 65° C. overnight. A porous polymer separator of 25 micrometer thickness was glued onto the flange of a electroformed gold can using UV-curing adhesive. A small piece of Li was attached to a 10 um copper foil lid using thermal bonding at 100° C. for 15 minutes. The lid was glued onto the can using the same adhesive. The assembly was infiltrated with a liquid electrolyte having a 1.33 to M concentration of LiPF₆ in a mixture of organic carbonates, through a small hole drilled in the copper foil. The cell was charged to 4.2 V at a constant current at C/15. Finally the drill hole was sealed with the adhesive and the whole assembly is shown in FIG. 20.

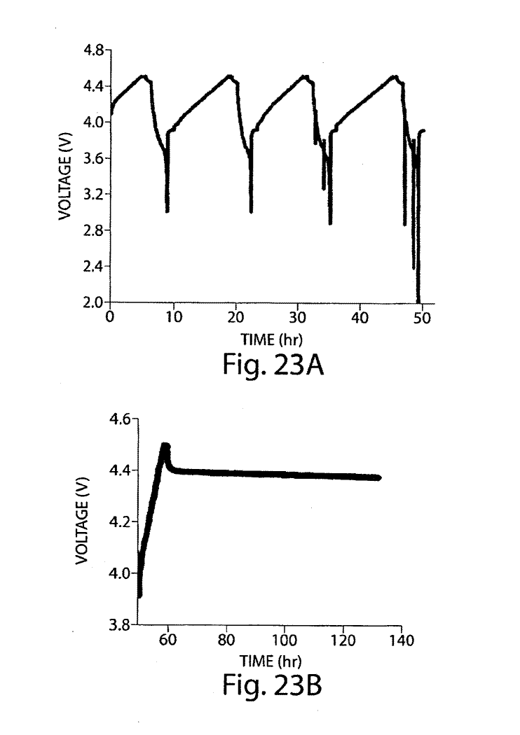

FIG. 23A shows the first four charge-discharge cycles of this cell. The charge protocol used a constant current at C/15 rate to an upper voltage of 4.5 V, followed by a constant voltage hold until the current decayed to C/33 rate, followed by a constant current discharge to 2.5 V or 2 V. The average energy density and power density for the first four cycles are 398 W h/L+157 W/L, 344 W h/L+156 W/L, 409 W h/L+154 W/L and 388 W h/L+154 W/L respectively. The peak power at 1 mA for the third cycle was 627 W/L. The peak power at 4 mA for the fourth cycle was 1766 W/L. FIG. 23B shows the fifth charge process followed by an open circuit period. It was shown the cell can hold its charge for more than 70 hours.

### Example 5

This example describes the fabrication of a 5 mm² battery package, according to one set of embodiments. The package was fabricated as two separate pieces: a “can” used to house the battery and a cover comprising the electrodes. After assembling the components of the battery within the can and the cover, the two pieces were bonded to form a hermetically sealed package.

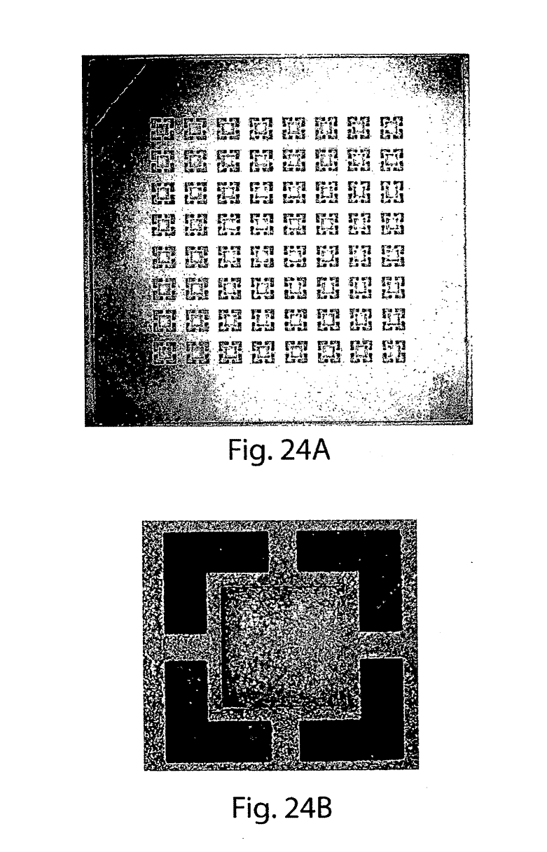

To begin, an 8×8 array of square molds measuring approximately 2.5 mm by 2.5 mm were etched into a silicon wafer using standard microfabrication processes. After the molds were etched into the wafer, a 100 micron-thick layer of copper was electroformed on the surface of the wafer, resulting in a substantially even coating of the interiors of the mold volumes. The deposited copper was etched to form a pattern of release tabs, as shown in FIG. 24A. Finally, the silicon under the array of molds was etched to produce freestanding “cans,” as shown in FIG. 24B.

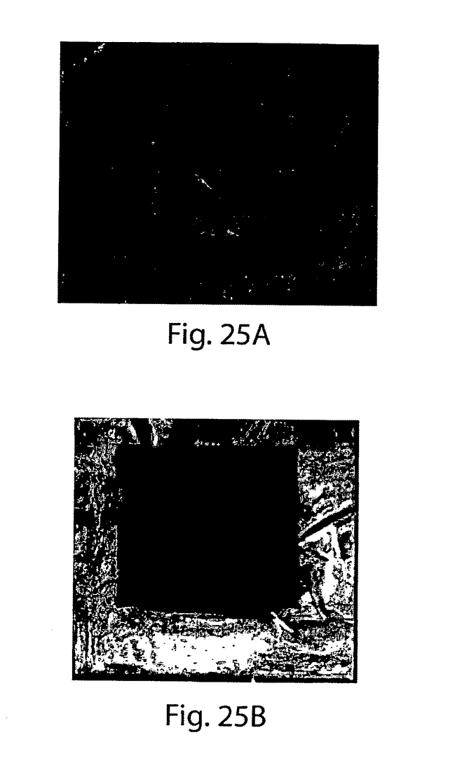

While this example describes the fabrication of cans from copper, a variety of materials may be used. For example, cans may be formed from a Ni/Cu alloy and coated with gold. In some embodiments, the cans may be replated (once, twice, or more) with gold. In some embodiments, the bulk of the can may be formed from a material other than copper such as, for example, gold, aluminum, or ceramic. In addition to plating metals within a mold, cans may be formed, for example, by stamping or vacuum forming a metal (e.g., aluminum) foil. An example of aluminum cans fabricated by stamping aluminum foil over a mandrel is shown in FIGS. 25A-25B. Cans may also be formed by bulk etching or machining (e.g., electro-discharge machining) a material (e.g., ceramic, metal, etc.) to form the cavity followed by numerically controlled milling the shape the exterior of the can.

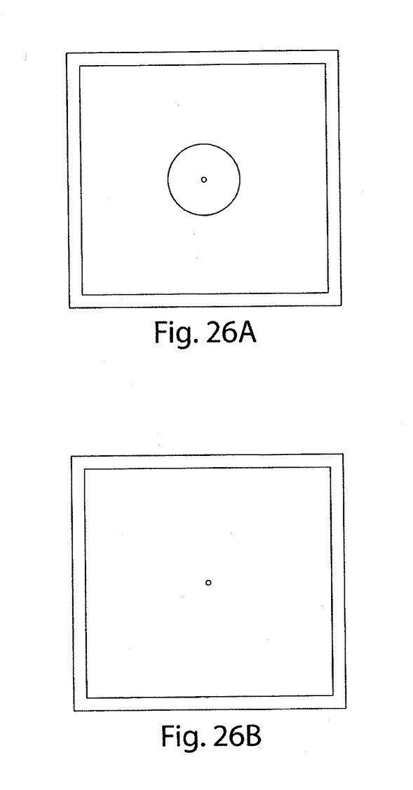

The cover was fabricated using MicroConnex Liquid Crystal Polymer. Suitable materials in which the cover may be formed include, for example, metallized liquid crystal polymer, gold-free metallized liquid crystal polymer, and alumina. To begin, a piece of polymer measuring roughly 2.35×2.8 mm was provided. A hole was formed through the body of the cover, roughly in its center. The center hole acted as a via, connecting the front and back side metallization and allowing for electrical access to the anode from outside the package. Using standard metal deposition techniques, metallization was deposited on both sides of the cover. Two metallization designs were investigated. In the coplanar terminal design, the metallization patterns on the top and bottom of the polymer are substantially the same, and are illustrated in FIG. 26A. In the single terminal design, a layer of metal was formed on the top side of the cover in the pattern shown in FIG. 26A, and another layer of metal was formed on the bottom side of the cover, in the pattern shown in FIG. 26B. In the examples shown in FIGS. 26A-B, the top side was coated with a layer of copper while the bottom side was coated with copper with a Ni/Au finish. The metal deposition steps were performed such that the center hole was filled with enough copper to ensure electrical conductivity between the front and back sides. After metallization, a second hole was drilled through the thickness of the cover. This hole served as an access port through which liquid electrolyte could be transported. In some cases, two or more holes were drilled through the cover to allow for the escape of air during electrolyte loading.

### Example 6

This example describes the assembly of batteries using the packages described in Example 1. To assemble the battery, a can was cut from the array. A cathode was provided for positioning within the can. Cathodes were attached to cans using a variety of methods. In one set of experiments, the bottom of the cathode was coated with metal (e.g., copper) via sputter deposition. A solder paste was applied to the bottom surface of the inside of the can. The solder paste was used to form a bond between the bottom surface of the can and the sputter-deposited copper layer of the cathode.

In other experiments, an LCO cathode was bonded to Au using a PvDF/carbon suspension.

In another set of experiments, a gold bump process was used to attach the cathode to the bottom of the can. In this process, a series of gold bumps were applied to the bottom surface of the can. Additionally, gold was sputtered onto the bottom surface of the cathode. The cathode was inserted into the can, with the gold sputtered surface of the cathode in contact with the gold-dotted surface of the can. A 400-gram weight was applied, and the stack was heated to 380° C., resulting in a permanent bond between the cathode and the can.

In yet another set of experiments, a piece of aluminum foil was placed at the bottom of the can. Gold was sputtered onto the bottom surface of the cathode. The cathode was inserted into the can, with the gold sputtered surface of the cathode in contact with the aluminum foil. An 800-gram weight was applied, and the stack was heated to 380° C., resulting in a permanent bond between the cathode and the can. Not wishing to be bound by any theory, the bond may have formed due to the interdiffusion between gold and aluminum at the cathode/can interface.

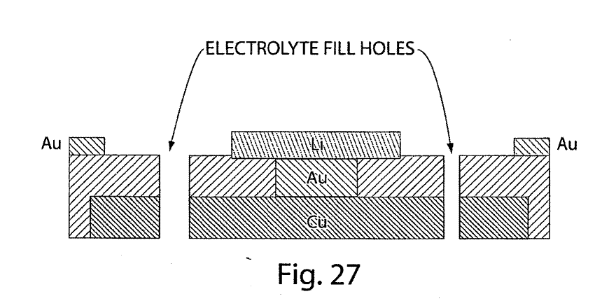

Prior to sealing the package, an anode was mounted to the side of the cover to be oriented facing the cavity of the can. In one set of experiments, a Li anode was mounted to the inside surface of the cover in a glove box. The lithium was oriented such that it was in contact with the gold via through the polymer cover, as illustrated schematically in FIG. 27. In other experiments, carbon was mounted to the cover and used as the anode material.

In some experiments, a separator layer was positioned over the cathode in order to separate the anode and cathode upon final assembly. In one set of experiments, a substantially conformal coating of LiPON was deposited on the cathode. Examples of suitable separator materials include polymers (e.g., Celgard, etc.), LiPON, a machined glass sleeve, etc.

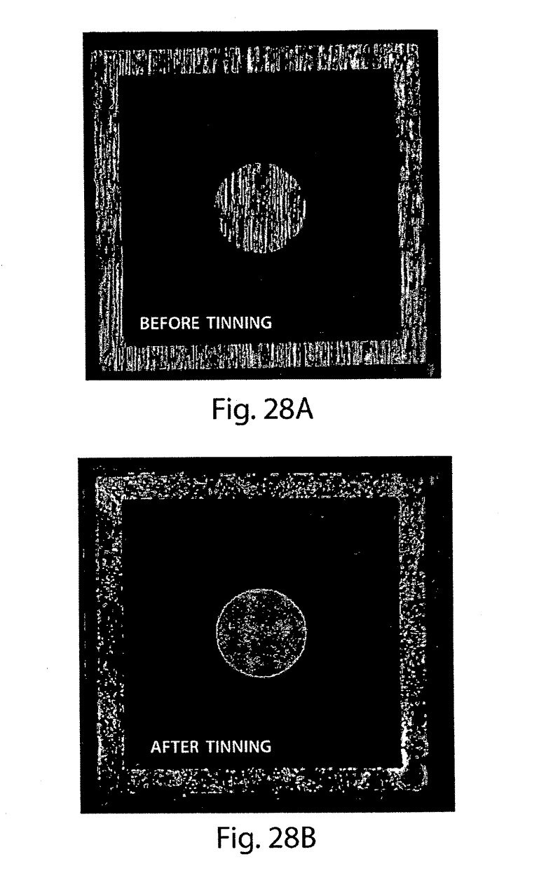

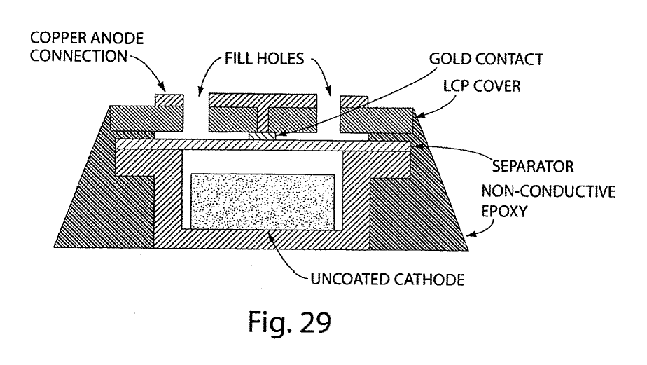

Once the cathode and anode were mounted, the can and the cover were positioned and sealed. In one set of experiments, the batteries were sealed using solder. A layer of solder was deposited around the perimeter of the top side of the can. A layer of tin was applied over the metallization on the perimeter of the cover, as shown in FIGS. 28A-28B. The cover was positioned over the can, with the anode side facing the interior of the can. Glass plates were used to secure the can and the cover in place. Once the cover was positioned, the solder between the can and the cover was reflowed, producing a seal. In other experiments, the cover was sealed to the can using a non-conductive epoxy, as shown schematically in FIG. 29.

In other experiments, Locktite 3972 acrylic, a UV curable adhesive was used to seal the can/cover interface. In this set of experiments, a thin layer of acrylic was stamped onto the flange on the upper portion of the can. The cover was then placed over the can. Finally, the stack was irradiated from each side, each for 30 seconds, producing a seal.

In still other experiments, a film of Tack Rflex 1000 adhesive was used to seal the cover to the can. To produce a seal, the adhesive film is positioned over the can, the cover is positioned over the film, and the stack is heated.

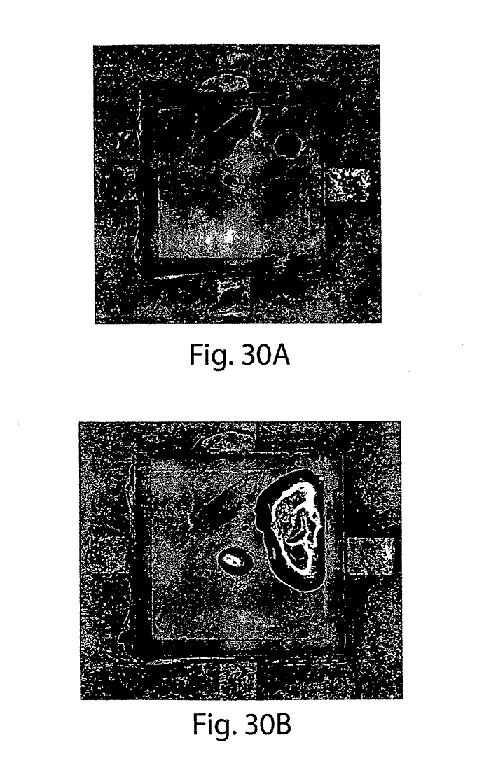

Once the cover was sealed on the can, the interior of the package was filled with electrolyte by introducing it through the access port. Sealed cells were immersed in liquid electrolyte in a glove box. The pressure in the glove box was cycled between 1 atm in argon and a partial vacuum 4 or 5 times. The cells was then allowed to soak for 16 hours. Next, the pressure in the glove box was again cycled between 1 atm in argon and partial vacuum 4 or 5 times. Finally, excess electrolyte was removed, and the access port(s) and center via were sealed using solder, as shown in FIGS. 30A-30B. In some cases, the cover of the package included a single access port, while in other cases, multiple access ports were present in the cover.

### Example 7

This example describes the study of electrochemical corrosion within the fabricated cells during operation. Exposed Ni/Cu can lead to electrochemical corrosion in some cases. Ni/Cu remained exposed in some cases due to incomplete Au plating. Also, the cut tabs of the can included exposed Ni/Cu at their edges.

Systematic cyclic voltammetry (CV) tests were performed to determine sources of electrochemical corrosion of components used for attachment and packaging in assembled cells. From the CV tests, it was determined that Pb—Sn solder (e.g., for attachment of cathodes and/or covers to cans) was electrochemically unstable at battery operating voltages if it is in contact with any electrolyte.

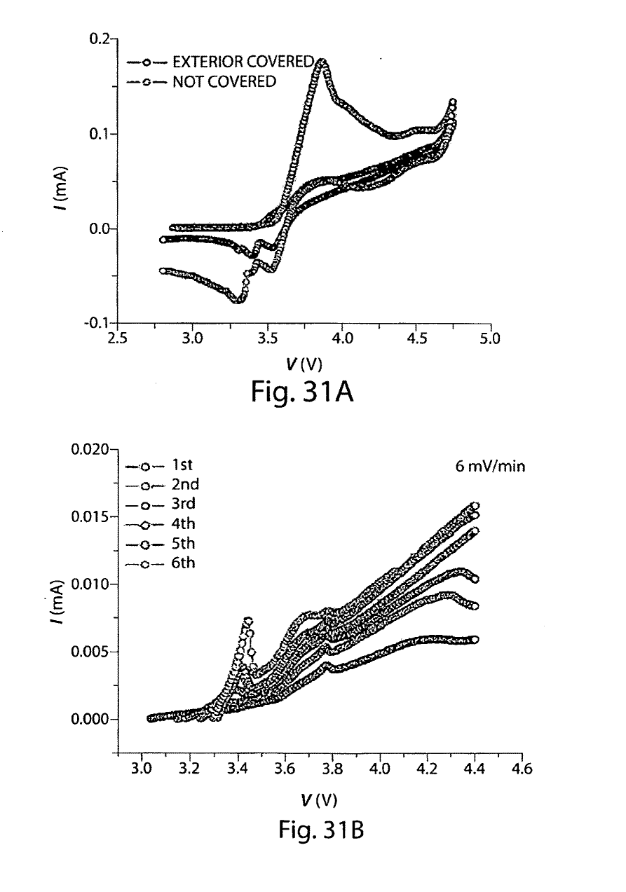

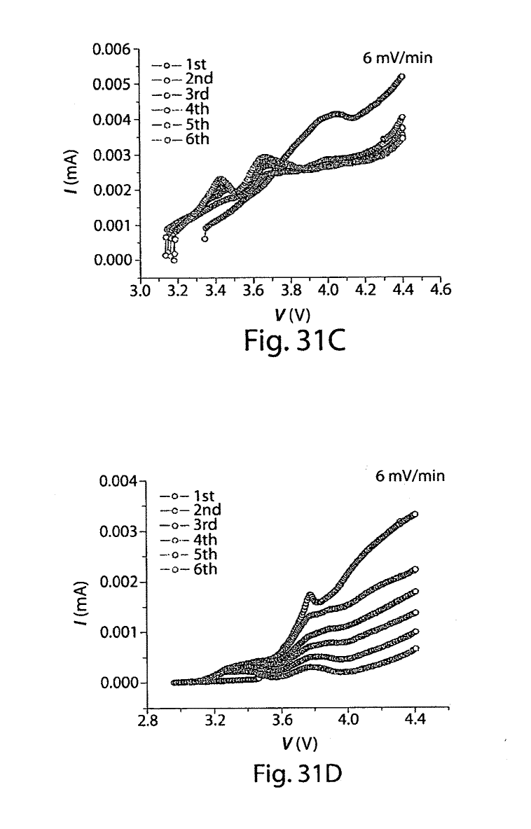

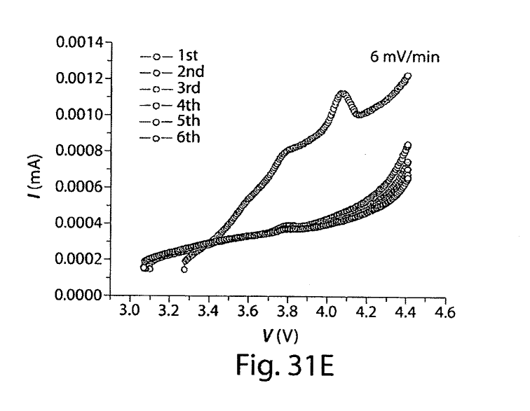

Au-coated Ni—Cu was stable as long as the Au coating layer was not damaged to expose Ni—Cu. FIG. 31A includes a plot of current as a function of voltage for a two cells: one in which the Ni—Cu cans were completely covered with Au, and another in which the Ni—Cu cans were not completely covered. The cans that were incompletely plated with Au exhibited a large corrosion current of about 0.1 to 0.2 mA. Another set of experiments were performed in which an additional 5 microns of Au plating was deposited on the cans. The corrosion current decreased, in all cases, by an order of magnitude to 0.015 mA or less, as shown in FIG. 31B. Yet another set of experiments was performed in which the cans were plated with an additional 10 microns of Au. This resulted in a further decrease in corrosion current to a maximum of 0.005 mA, as shown in FIG. 31C.

The epoxies included residual impurities that were oxidized during the first charge, but were otherwise stable. FIG. 31D includes a plot of current as a function of voltage for cells sealed using Locktite 3972 acrylic, a UV-curing adhesive. The maximum corrosion current of ˜0.003 mA was observed at 4.4 V during the first cycle. Subsequent cycles exhibited decreased corrosion currents, with the sixth cycle exhibiting a corrosion current of 0.0005 mA at 4.4 V.

Finally, a set of experiments was performed using cans fabricated substantially entirely from gold. These cans showed very low corrosion, with a maximum corrosion current of about 0.0012 mA at 4.4 V, as shown in FIG. 31E.

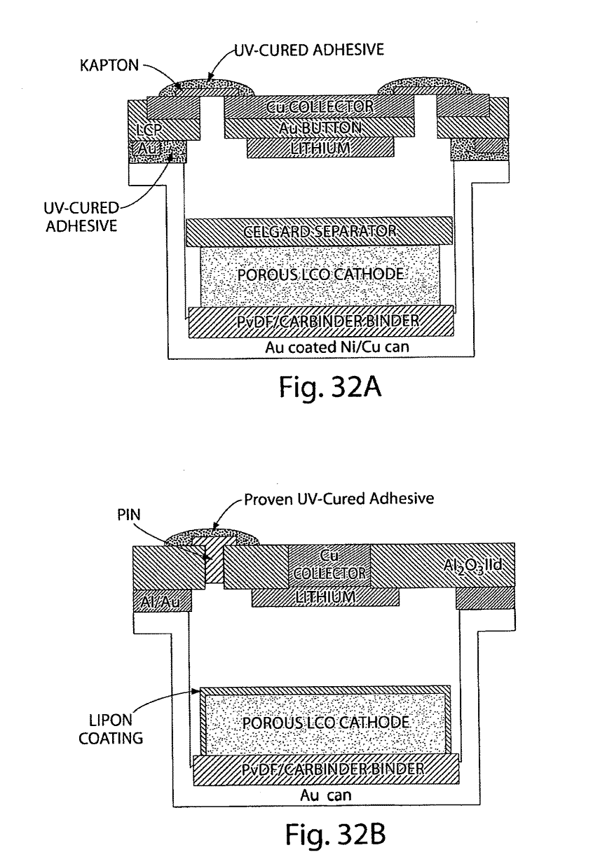

Examples of designs that have been verified as corrosion-proof are shown in FIGS. 32A-32B.

### Example 8

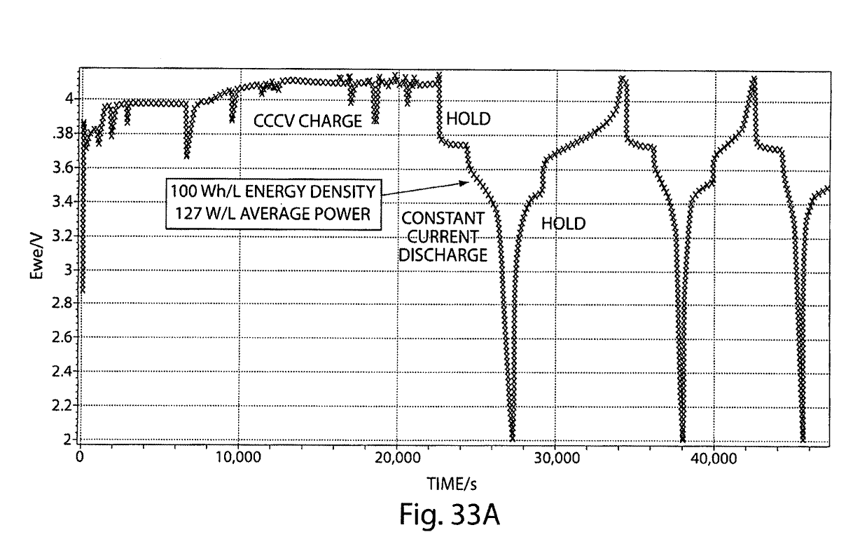

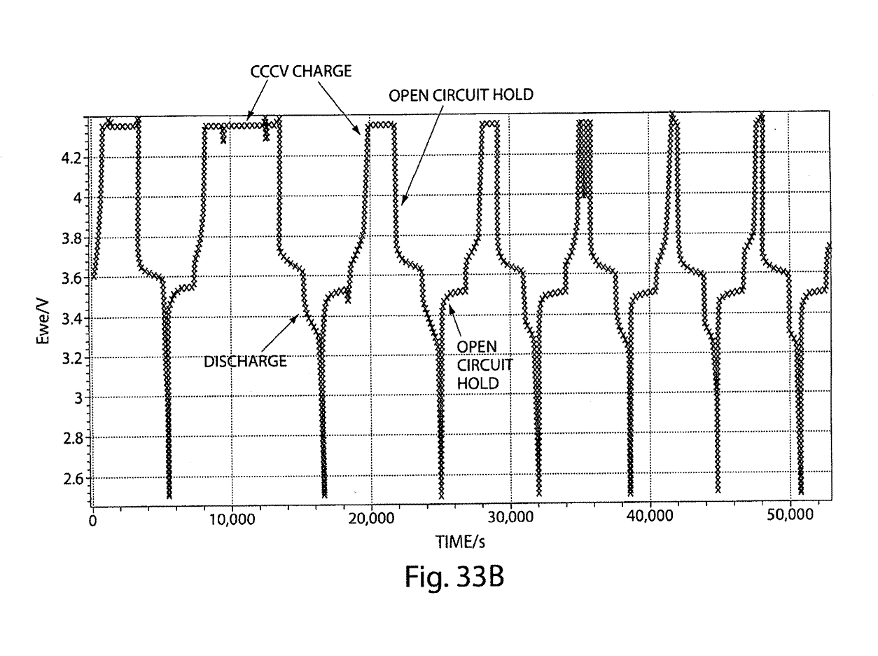

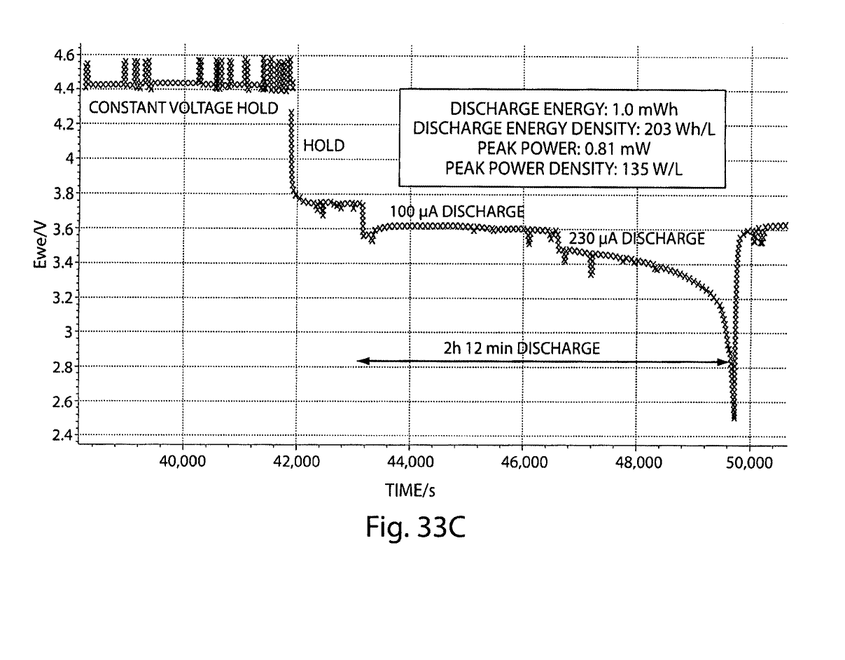

This example describes the testing of sealed and unsealed cells. FIG. 33A includes a plot of voltage vs. time for an unsealed, 5 mm³ LiCoO₂—Li metal cell using an uncoated cathode. The average power for this cell was 127 W/L, while the energy density was 100 Wh/L. FIGS. 33B-C include plots of voltage vs. time for an unsealed, 5 mm³ LiCoO₂—Li metal cell using a 1 micron deposited UPON separator. FIG. 33C illustrates a discharge energy of 1.0 mWh, a discharge energy density of 203 Wh/L, a peak power of 0.81 mW, and a peak power density of 135 W/L.

### Example 9

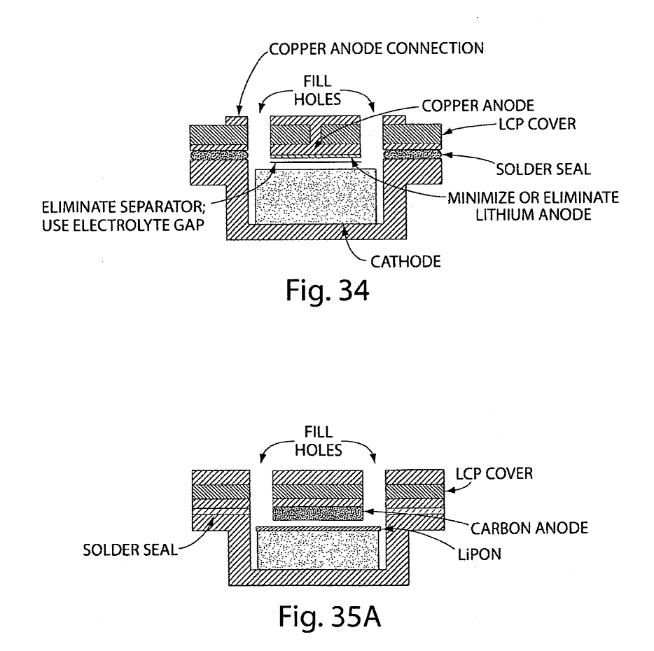

In some instances, it may be advantageous to use an anode-less cell. A schematic illustration of an anode-less cell is shown in FIG. 34. The role of a lithium metal anode in a traditional design is to compensate for irreversible losses and to provide a “seeding” surface for Li deposition upon charging. When a lithiated cathode (LiCoO₂) is used, the cathode becomes the primary source of working lithium within the cell, and the Li metal anode can be minimized or removed entirely. In addition, this design does not require a separator between the anode and the cathode; rather an electrolyte-filled gap may be used alone. By eliminating the separator, a higher rate capability is expected.

### Example 10

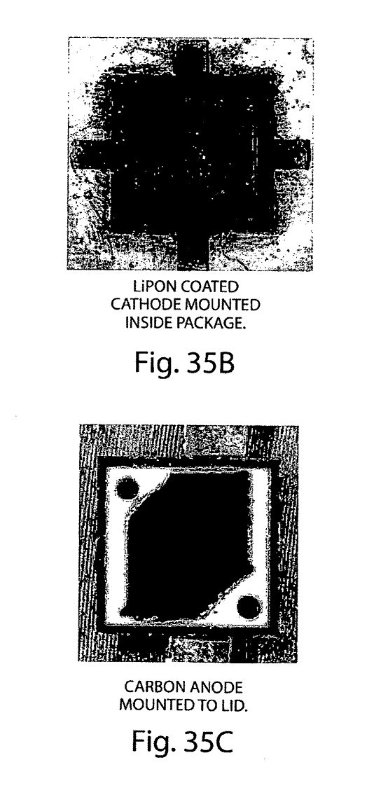

In this example, the lithium metal anode is replaced with a carbon anode. An example of such an alternative is shown in FIGS. 35A-35C. Lithium metal anodes require cell assembly in controlled environments (e.g., a dry room or glove box). Since the anode in the traditional cell design serves primarily as a “seeding” surface for lithium deposition, other materials may be used for the anode when a lithiated cathode is used. Graphite anodes, such as those used in conventional lithium ion cells, may serve the same function and allow air-assembly. Final electrolyte filling is still be conducted in controlled environment, as with conventional Li-ion batteries.

### Example 11

The techniques used to fabricated the cells described herein may be scaled to produce, in parallel, a large number of cells simultaneously. An array of cathodes can be simultaneously fabricated using thick-film processing, laser trimming, and LiPON deposition. An example of the alignment of an array of battery components is shown in FIG. 18D. In some cases, the metallized covers may be positioned over the array of cans, and the array of cells may be simultaneously sealed (e.g., via flash-lamp sealing of solder).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An article, comprising:
a battery comprising an entire anode, an electrolyte, and an entire cathode, the battery having a volume of no more than about 10 mm³, the battery being contained within a sealed container including at least one metallized portion.

2. The article of claim 1, wherein the container comprises a lid, the lid comprising the metallized portion.

3. The article of claim 1, wherein the lid comprises a metallic feedthrough.

4. An article, comprising:
a battery comprising an entire anode, an electrolyte, and an entire cathode, the battery having a volume of no more than about 10 mm³, the battery being contained within a sealed container including at least one metallic feedthrough.

5. The article of claim 1, wherein the container comprises a liquid electrolyte.

6. The article of claim 1, wherein the container comprises a polymer electrolyte.

7. The article of claim 1, wherein the battery has a volume of no more than about 5 mm³.

8. The article of claim 1, wherein the container is a 5-sided container.

9. A method, comprising:
positioning a polymer film containing one or more metallized portions containing solder adjacent a container at least partially enveloping a battery, wherein the battery includes an entire anode, an electrolyte, and an entire cathode, and the battery has a volume of no more than about 10 mm³;
heating the one or more metallized portions to at least partially melt the solder; and
forming a seal between the container and the polymer film.

10-11. (canceled)

12. The method of claim 9, wherein the act of heating comprises heating using high intensity light.

13. (canceled)

14. The method of claim 9, wherein the battery includes an entire anode, an electrolyte, and an entire cathode, and the battery has a volume of no more than about 5 mm³.

15. The method of claim 9, wherein the container comprises a metal.

16-17. (canceled)

18. The method of claim 9, further comprising positioning a mask over the polymer film.

19. The method of claim 18, wherein the mask comprises glass.

20. The method of claim 18, wherein the mask contains reflective foil.

21. The method of claim 18, wherein the container is a 5-sided container.

22-33. (canceled)

34. The method of claim 9, wherein the container comprises copper.

35. The method of claim 9, wherein the container comprises nickel.

36. The method of claim 9, wherein the container comprises gold.

37. The method of claim 9, wherein the container comprises silver.

38-52. (canceled)

53. The method of claim 9, wherein the polymer film comprises a metallization layer deposited thereon.

54. The method of claim 1, wherein the sealed container comprises one or more of a polymer, a metal, and a ceramic.
